(19) United States
(12) Patent Application Publication
(10) Pub. No.: US 2023/0106817 A1
(43) Pub. Date: Apr. 6, 2023

(54) SILICA-REINFORCED RUBBER COMPOSITIONS AND ARTICLES MADE THEREFROM

(71) Applicant: Momentive Performance Materials Inc., Waterford, NY (US)

(72) Inventors: Christopher PAPPAS, Charlotte, NC (US); Richard W. CRUSE, Yorktown Heights, NY (US); Eric Raymond POHL, Mount Kisco, NY (US); Aaron RYBA, Charlotte, NC (US); Michael YORK, New Fairfield, CT (US)

(73) Assignee: Momentive Performance Materials Inc., Waterford, NY (US)

(21) Appl. No.: 17/938,634

(22) Filed: Oct. 6, 2022

Related U.S. Application Data
(60) Provisional application No. 63/252,809, filed on Oct. 6, 2021.

(51) Int. Cl. C08F 236/06; C08F 212/08; C08C 19/25; C08K 5/548; C08K 3/36; C08K 3/06; C08K 5/372; B60C 1/00

(52) U.S. Cl. CPC C08F 236/06; C08F 212/08; C08C 19/25; C08K 5/548; C08K 3/36; C08K 3/06; C08K 5/3725; B60C 1/0016; C08K 2201/014

(57) ABSTRACT

Rubber compositions comprising at least one diene based polymer, a precipitated silica, a coupling agent package comprising a mercapto-functional alkylalkoxysilane and a blocked mercapto-functional alkylalkoxysilane, a deblocking agent, a vulcanizing package comprising at least one vulcanizing agent comprising sulfur and at least one accelerator, and a scorch modifier are provided herein.

### FIELD OF THE DISCLOSURE

The present disclosure relates to rubber compositions comprising at least one diene based polymer, a precipitated silica, a coupling agent package comprising a mercapto-functional alkylalkoxysilane and a blocked mercapto-functional alkylalkoxysilane, a deblocking agent, a vulcanization package and a scorch modifier and cured composition thereof.

### BACKGROUND

Tire companies are constantly searching for new rubber technology to lower rolling resistance of tires to improve fuel economy of vehicles without compromising the safety, handling, traction, service time, and industrial feasibility of the tire. One approach to achieving this need has been to use silica reinforced rubbers wherein the silica is coupled to the rubber using coupling agents containing an alkoxysilyl groups capable of reacting with the silica filler and a functional group capable of reacting with the rubber during processing and/or cure.

A variety of coupling agents that have been used, including amino-functional alkylalkoxysilanes, bis-(alkylalkoxysilane) disulfides, bis-(alkylalkoxysilane) polysulfides, blocked mercapto-functional alkylalkoxysilane, mercapto-functionalized alkylalkoxysilane among other silicon based coupling agents. These coupling agents have been used generally with non-functionalized solution styrene butadiene rubbers and precipitated silica. Although these composition have improved the rolling resistance compared to carbon black reinforced rubbers, these compositions often suffer from a loss of other properties such as handling and wear, and still do not fulfill the need for still further improvements in rolling resistance.

Further, using mercapto-functional alkylalkoxysilane containing silica rubber compounds during processing and before curing in a tire is historically very challenging, resulting in unacceptably high Mooney viscosity and poor scorch safety even in the presence of scorch modifiers.

Another approach has been to use diene based rubbers containing at least one functional group capable of interacting with the silica surface. However, the processability of rubber compositions containing mercapto-alkylalkoxysilane, precipitated silica and diene based rubbers containing at least one functional group has unacceptably high Mooney viscosity and short scorch times. This results in unfavorable or unacceptable processing properties and creates difficulties in mixing, milling, extrusion, tire construction, and tire curing. These issues are usually prohibitive for industrializing rubber compositions containing diene based rubbers containing functional groups and most mercapto-function alkylalkoxysilane compounds. Therefore, there is a need for rubber compositions with improved rolling resistance performance while balancing other key performances such as tread, grip (traction and braking), wear and handling while overcoming industrial processability challenges, such as high Mooney viscosity and poor scorch safety.

### BRIEF SUMMARY OF THE DISCLOSURE

Rubber compositions disclosed herein comprise:

(i) at least one diene based polymer;

(ii) precipitated silica;

(iii) at least one coupling agent package comprising a mercapto-functional alkylalkoxysilane (iii)(a) and a blocked mercapto-functional alkylalkoxysilane (iii)(b);

(iv) at least one deblocking agent;

(v) a vulcanization package comprising comprising at least one vulcanizing agent that comprises sulfur and at least one accelerator; and

(vi) at least one scorch modifier.

In some aspects, the at least one diene based polymer is selected from the group consisting of a diene based polymer containing at least one functional group (i)(a), a diene based polymer containing no functional group (i)(b), and combinations thereof.

In another aspect, the at least one diene based polymer is a diene based polymer containing at least one functional group and a diene based polymer containing no functional group.

In other aspects, the at least one diene based polymer is a diene based polymer containing at least one functional group (i)(a).

In some aspects, the at least one functional group is selected from the group consisting of amino groups, alkoxysilyl groups, stanyl groups, hydroxyl groups, thiol groups, sulfido group, thioisocyanato group, isocyanato groups, imino groups, pyridino groups, epoxy group, thioepoxy groups, thioketone groups, ketone groups, ketimine groups, isocyanuric acid groups, amido groups, silazano groups, hydroxysilyl (silanol) groups, siloxane groups, phthalocyanino groups, silane-sulfide groups, carboxylic acid groups, carboxylic acid ester groups, and combinations thereof. In some aspects, the at least one functional group is an alkoxylsilyl group.

In some aspects, the diene based polymer containing at least one functional group is solution styrene butadiene rubber containing functional groups selected from amino groups, alkoxysilyl groups, stanyl groups, hydroxyl groups, thiol groups, sulfido group, thioisocyanato group, isocyanato groups, imino groups, pyridino groups, epoxy group, thioepoxy groups, thioketone groups, ketone groups, ketimine groups, isocyanuric acid groups, amido groups, silazano groups, hydroxysilyl (silanol) groups, siloxane groups, phthalocyanino groups, silane-sulfide groups, carboxylic acid groups and/or carboxylic acid ester groups. The functional groups can be used alone or can be combined in the terminal position or pendent position to form dual functional group terminals or dual function group pendent groups, as for example, the terminal position of the diene based polymer can contain alkoxysilyl and primary amino groups, or alkoxysilyl and thiol groups.

In some aspects, the diene based polymer is one that reacts with the precipitated silica. In a further aspect, the diene based polymer containing at least one functional group reacts with the precipitated silica. In some aspects, the diene based polymer is solution styrene butadiene rubber containing alkoxylsilyl groups. In some aspects, the diene based polymer contains at least one functional group that can bond to the precipitated silica and/or with itself to reduce or eliminate dangling end. Each diene based polymer chain (or 1 mole of polymer) in a polymer matrix has two dangling ends, also known as end groups or polymer chain ends. When a polymer chain end is functionalized with a chemical group reactive to the silica surface, one dangling end is essentially eliminated because of the covalent bond between the polymer chain end and the silica surface. Due to the greater degree of freedom of a dangling end compared to polymer chain length between crosslinks or a covalently bonded chain end, it significantly contributes to the hysteresis of the polymer matrix, which gives worse rolling resistance properties to the rubber tread compound.

In some aspects, the mercapto-functional alkylalkoxysilane, hereinafter referred to as mercaptosilane, in the compositions disclosed herein is a bifunctional silane that has thiol (mercaptan) and alkoxysilane functionalities bonded to an alkane via single covalent bonds.

In some aspects, the blocked mercapto-functional alkylalkoxysilane, hereinafter referred to as blocked mercaptosilane, in the rubber compositions disclosed herein is a bifunctional silane in which one functional group is a thiol (mercaptan) where the mercapto hydrogen atom is replaced with another group (hereafter referred to as “blocking group”) and the other functional group is an alkoxysilyl group, where the blocked mercapto group and alkoxysilyl group are bonded to an alkane via single covalent bonds. Specifically, the silanes can be blocked mercaptosilanes in which the blocking group contains an acyl group bonded directly to sulfur via a single bond to form a thioester functional group or in which the blocking group is a thiocarboxyl group bonded directly to sulfur via a single bond to form a xanthate functional group (—OC═S)S—.

In some aspects, the weight ratio of the blocked mercapto-functional alkylalkoxysilane (iii)(b) to the mercapto-functional alkylalkoxysilane (iii)(a) in the rubber compositions disclosed herein is about 0.25:1 to about 50:1. In some aspects, the weight ratio of the blocked mercapto-functional alkylalkoxysilane (iii)(b) to the mercapto-functional alkylalkoxysilane (iii)(a) in the rubber compositions disclosed herein is about 0.5:1 to about 20:1. In some aspects, the weight ratio of the blocked mercapto-functional alkylalkoxysilane (iii)(b) to the mercapto-functional alkylalkoxysilane (iii)(a) in the rubber compositions disclosed herein is about 1:1 to about 10:1.

in some aspects, the weight ratio of the blocked mercaptosilane to the mercaptosilane in the rubber compositions disclosed herein is about 0.25:1 to about 50:1.

In some aspects, the at least one coupling agent package (iii) is used in an amount of from about 0.5 to about 20 parts by weight coupling agent package per 100 parts by weight rubber, more specifically from about 1 to about 10 parts by weight coupling agent package (iii) per 100 parts by weight rubber, and even more specifically from about 3 to about 8 parts by weight coupling agent package (iii) per 100 parts by weight rubber.

In some aspects, the scorch modifier may be selected from the group consisting of scorch modifiers include tetramethylthiuram disulfide, tetraethylthiuram disulfide, tetrapropylthiuram disulfide, tetrabutylthiuram disulfide, tetraphenylthiuram disulfide, tetramethylthiuram monosulfide, zinc dibenzyl dithiocarbamate, and tetrabenzylthiuram disulfide, and combinations thereof.

In some aspects, the scorch modifier is a thiuram disulfide scorch modifier. In some aspects, the scorch modifier is tetra-benzylthiuram disulfide or tetramethylthiuram disulfide.

In some aspects, the rubber composition comprises

(i) about 100 parts of rubber, where the weight of the rubber is the total weight from adding the sum of the weights of each diene based polymer containing at least one functional group (i)(a) used in the formulation and sum of the weights of each diene based polymer which does not contain the at least one functional group (i)(b);

(ii) about 5 to about 140 parts by weight per 100 parts rubber (i) of precipitated silica;

(iii) about 1 to about 20 parts by weight per 100 parts rubber (i) a coupling agent package comprising a mercapto-functional alkylalkoxysilane and a blocked mercapto-functional alkylalkoxysilane;

(iv) about 0.1 to about 20 parts by weight per 100 parts rubber (i) a deblocking agent;

(v) about 0.1 to about 10 parts by weight per 100 parts rubber (i) a vulcanization package comprising sulfur and at least one accelerator; and

(vi) about 0.1 to about 5 parts by weight per 100 parts rubber (i) a scorch modifier.

The units for the parts by weight per 100 parts rubber (i) is often referred to as phr. The sum of the weight of each diene based polymer containing at least one functional group (i)(a) make up from 0 to about 100 parts by weight per 100 parts of the rubber (i), more specifically from about 10 to about 100 parts by weight per 100 parts of the rubber (i), even more specifically from about 20 to about 95 parts by weight per 100 parts of the rubber (i), and still even more specifically from about 50 to about 90 parts by weight per 100 parts rubber, where the remainder of the rubber component (i) is the sum of the weight of the diene based polymer which does not contain the at least one functional group (i)(b).

In some aspects, the rubber composition is cured.

Rubber compositions disclosed herein exhibit a synergistic effect between diene based polymer containing at least one functional group, a precipitated silica, a coupling agent package comprising a mercapto-functional alkylalkoxysilane and a blocked mercapto-functional alkylalkoxysilane, and a thiuram disulfide scorch modifier. The synergistic effect is observed for many different diene based polymer containing different functional groups resulting in low rolling resistance, while maintaining or improving other performance features. In some aspects, the synergistic effect is demonstrated by a higher Performance Index Value.

In some aspects, the composition of this disclosure has a higher Performance Index Value compared to the same composition without the mercaptosilane. In some aspects, the composition has a higher Performance Index Value compared to the same composition without the blocked mercaptosilane. In some aspects, the composition has a higher Performance Index Value compared to the same composition in which the functional polymer is replaced by a non-functional polymer.

The disclosure further provides a composition prepared by a process of this disclosure. In some aspects, the composition prepared by a process of this disclosure is a rubber composition. In some aspects, the rubber composition is used to make a tire.

### DETAILED DESCRIPTION

As used above, and throughout the description, the following terms, unless otherwise indicated, shall be understood to have the following meanings.

Unless stated otherwise, the terms “a” and “an” and “the” and similar references used in the context of describing a particular aspect of the application (especially in the context of claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

Furthermore, “and/or”, where used herein, is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following aspects: A, B, and C; A, B, or C; A or C; A or B; B or C; A and C; A and B; B and C; A (alone); B (alone); and C (alone).

It is understood that wherever aspects are described herein with the language “comprising,” otherwise analogous aspects described in terms of “consisting of” and/or “consisting essentially of” are also provided.

The term “polymer” means a substance, chemical compound or mixture of compounds, that has a molecular structure consisting chiefly or entirely of a large number of similar units (e.g., monomer units) bonded together.

The term “functionalized diene based polymer” is synonymous, and therefore interchangeable, with “diene based polymer containing at least one functional group (i)(a)”.

The term “non-functionalized diene based polymer” is synonymous, and therefore interchangeable with “diene based polymer containing no functional groups (i)(b)”.

As used herein, the term “about” encompasses the range of experimental error that occurs in any measurement.

The term “elastomer” is synonymous, and therefore interchangeable, with “rubber”.

The term “vulcanized” is synonymous, and therefore interchangeable, with “cured”.

The expression “blocked mercaptosilane(s)” shall be understood to include partial hydrolyzates. Partial hydrolyzates of blocked mercaptosilanes result from some methods of their manufacture and/or can occur upon their storage, especially under humid conditions.

The expression “coupling agent” means an agent capable of establishing an effective chemical and/or physical bond between a diene based polymer and a filler or means an agent capable of establishing an effective chemical or physical bond between two diene based polymers. Effective coupling agents have functional groups capable of bonding physically and/or chemically with filler or a second diene based polymer, as for example, between a silanol group of the coupling agent and the hydroxyl (OH) surface groups of the filler (e.g., surface silanols in the case of silica), or between a silanol group attached to one diene polymer with the silanol group of another polymer, and, as for example, sulfur atoms which are capable of bonding physically and/or chemically with the diene based polymers as a result of vulcanization (curing).

The term “filler” means a substance that is added to the diene based polymer (rubber) to either extend the rubber or to reinforce the elastomeric network. Reinforcing fillers are materials whose moduli are higher than the diene based polymer of the elastomeric composition and are capable of absorbing stress from the diene based polymer when the elastomer is strained. Fillers include fibers, needles, nanotubes, particulates, and sheet-like structures and can be composed of inorganic minerals, silicates, silica, clay, ceramics, carbon, organic polymer and diatomaceous earth.

The term, “hydrocarbon” as used herein refers to any chemical structure containing hydrogen atoms and carbon atoms.

As used herein, “alkyl” includes straight, branched and cyclic alkyl groups; “alkenyl” includes any straight, branched or cyclic alkenyl group containing one or more carbon-carbon double bonds where the point of substitution can be either at a carbon-carbon double bond or elsewhere in the group; and, “alkynyl” includes any straight, branched or cyclic alkynyl group containing one or more carbon-carbon triple bonds and, optionally, one or more carbon-carbon double bonds where the point of substitution can be either at a carbon-carbon triple bond, a carbon-carbon double bond or elsewhere in the group.

Specific, non-limiting examples of alkyl groups include methyl, ethyl, propyl and isobutyl. Specific, non-limiting examples of alkenyls include vinyl, propenyl, allyl and methallyl. Specific, non-limiting examples of alkynyls include acetylenyl, propargyl and methylacetylenyl.

As used herein, “aryl” includes any aromatic hydrocarbon from which one hydrogen atom has been removed; “aralkyl” includes any of the aforementioned alkyl groups in which one or more hydrogen atoms have been substituted by the same number of like and/or different aryl (as defined herein) substituents; and “arenyl” includes any of the aforementioned aryl groups in which one or more hydrogen atoms have been substituted by the same number of like and/or different alkyl (as defined herein) substituents. Specific, non-limiting examples of aryl groups include phenyl and naphthalenyl. Specific, non-limiting examples of aralkyl groups include benzyl and phenethyl. Specific, non-limiting examples of arenyl groups include tolyl and xylyl.

As used herein, “alkylene” is a divalent saturated aliphatic radical derived from an alkane by removal of two hydrogen atoms.

Other than in the working examples or where otherwise indicated, all numbers expressing amounts of materials, reaction conditions, time durations, quantified properties of materials, and so forth, stated in the specification and claims are to be understood as being modified in all instances by the term “about”.

It will be understood that any numerical range recited herein includes all sub-ranges with that range and any combination of the various endpoints of such ranges or sub-ranges.

It will be further understood that any compound, material or substance which is expressly or implicitly disclosed in the specification and/or recited in a claim as belonging to a group of structurally, compositionally and/or functionally related compounds, materials or substances includes individual representatives of the group and all combinations thereof.

A composition of the disclosure exhibits a synergistic effect among a diene based polymer containing at least one functional group (i)(a), a blocked mercaptosilane, a mercaptosilane, and a scorch modifier in a silica rubber compound, and the synergistic effect is achieved using various diene based polymers (i)(a). In some aspects, the synergistic effect is demonstrated by a higher Performance Index Value.

In an aspect, the composition containing the diene based polymer (i)(a), mercaptosilane and blocked mercaptosilane all react on the surface of the silica during mixing. Both the diene based polymer (i)(a) and mercaptosilane will create silica and polymer chemical or physical bonds during mixing. The high reactivity of the thiol in the mercaptosilane may result in a bond with the diene based polymer during mixing, but not all thiols will have enough time to react during rubber mixing schemes designed for commercial manufacture for tires.

Rubber compositions disclosed herein comprise:

(i) at least one diene based polymer;

(ii) a precipitated silica;

(iii) a coupling agent package comprising a mercapto-functional alkylalkoxysilane and a blocked mercapto-functional alkylalkoxysilane;

(iv) a deblocking agent;

(v) a vulcanization package comprising sulfur and at least one accelerator; and (vi) a scorch modifier.

In some aspects, the rubber composition is cured.

In some aspects, the at least one diene based polymer is selected from the group consisting of a diene based polymer containing at least one functional group (i)(a), a diene based polymer containing no functional group (i)(b), and combinations thereof. In some aspects, the at least one diene based polymer is a combination of at least one diene based polymer containing at least one functional group (ia) and a diene based polymer containing no functional group (i)(b).

In some aspects, the rubber compositions comprise:

(i) a diene based polymer wherein the diene based polymer is a combination of at least one diene based polymer containing at least one functional group (i)(a) and a diene based polymer containing no functional group (i)(b);

(ii) precipitated silica;

(iii) at least one coupling agent package comprising a mercapto-functional alkylalkoxysilane (iii)(a) and a blocked mercapto-functional alkylalkoxysilane (iii)(b); (iv) at least one deblocking agent;

(v) a vulcanization package comprising at least one vulcanizing agent that comprises elemental sulfur and at least one accelerator; and

(vi) at least one scorch modifier.

### Diene Based Polymer (i)

Diene based polymer containing at least one functional group (i)(a)

The diene based polymer containing at least one functional group (i)(a) are compounds where the functional group is selected from the group consisting of amino groups, alkoxysilyl groups, stanyl (tin) groups, hydroxyl groups, thiol groups, sulfido group, thioisocyanato group, isocyanato groups, imino groups, pyridino groups, epoxy group, thioepoxy groups, thioketone groups, ketone groups, ketimine groups, isocyanuric acid groups, amido groups, silazano groups, hydroxysilyl (silanol) groups, siloxane groups, phthalocyanino groups, silane-sulfide groups, carboxylic acid groups, carboxylic acid ester groups and combinations of these functional groups.

In an aspect, the diene based polymer containing at least one functional group (i)(a) can contain the functional group(s) at one end of the polymer, at both ends of the polymer, at one end of the polymer and pendent to the polymer backbone, at both ends of the polymer and pendent to the polymer backbone or only pendent to the polymer backbone. The functional group at the end of the polymer (terminal group) or in-chain polymer (pendent group) can be a single functional group or two or more functional groups that can be present at one end of the polymer or pendent from the polymer backbone.

In an aspect, the diene based polymer containing at least one functional group (i)(a) can be prepared from solution anionic polymerization, solution free radical polymerization or free radical emulsion polymerization.

In an aspect, the diene based polymer containing at least one functional group (i)(a) is prepared by polymerizing monomer including, but not limited to, aromatic compounds containing an alkenyl group where the carbon-carbon double bond is in conjugation with the aromatic ring and from 8 to 20 carbon atom, dienes, such as 1,3-butadiene or isoprene, and compounds containing an alkenyl group and a functional group and/or protected functional group. A protected functional group is a functional group that has been reacted with a protecting agent to form a protected functional group which does not participate in or inhibits the participation of protected functional groups in the polymerization reaction, but can be removed after the polymerization reaction to regenerate the functional group. The polymerization reaction is initiated by an initiator and terminated by a terminating compound. The initiator and/or terminating compounds may contain functional groups and/or protected functional groups.

In an aspect, the diene based polymer containing at least one functional group (i)(a) can be prepared in accordance with U.S. Patent Publication No. 2010/0186869A1, U.S. Pat. No. 7,342,070 B2 and/or WO Publication No. 2007/047943, the entire contents of each are included herein by reference. The diene based polymer containing at least one functional group (i)(a) can be a styrene-butadiene rubber functionalized with an alkoxysilane group and at least one of a primary amine group and/or thiol group. The styrene-butadiene rubber is obtained by copolymerizing styrene and butadiene, and characterized in that the styrene-butadiene rubber has a primary amino group and/or thiol group and an alkoxysilyl group which are bonded to the polymer chain. The alkoxysilyl group may be at least one of methoxysilyl group and/or ethoxysilyl group. The primary amino group and/or thiol group may be bonded to any of a polymerization initiating terminal, a polymerization terminating terminal, a main chain of the styrene butadiene rubber and a side chain, as long as it is bonded to the styrene-butadiene rubber chain. The primary amino group and/or thiol group may be introduced to the polymerization initiating terminal or the polymerization terminating terminal.

In an aspect, the content of the alkoxysilyl group bonded to the polymer chain of the (co)polymer rubber is preferably from about 0.5 to about 200 millimole per kilogram (mmol/kg) of the diene based polymer containing at least one functional group (i)(a), more specifically, the content is from about 1 to about 100 mmol/kg of diene based polymer containing at least one functional group (i)(a), and particularly from about 2 to about 50 mmol/kg of diene based polymer containing at least one functional group (i)(a).

The diene based polymer containing at least one functional group (i)(a) can be prepared by polymerizing styrene and butadiene in a hydrocarbon solvent by anionic polymerization using an organic alkali metal and/or an organic alkali earth metal as an initiator, adding a terminating agent compound having a primary amino group protected with a protective group and/or a thiol group protected with a protecting group and an alkoxysilyl group to react the terminating agent with a living polymer chain terminal at the time when the polymerization has substantially completed, and then conducting deblocking, for example, by hydrolysis or other appropriate procedure.

In an aspect, the diene based polymer containing at least one functional group (i)(a) has the formula (I):

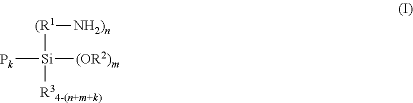

wherein

P is a (co)polymer chain of a conjugated diolefin or a conjugated diolefin and an aromatic vinyl compound;

R¹ is an alkylene group having 1 to 12 carbon atoms;

each R² and R³ is independently an alkyl group having 1 to 20 carbon atoms, an allyl group or an aryl group; and

k, m and n are each an integer, where n is 1 or 2, m is 1 or 2, and k is 1 or 2, with the proviso that n+m+k is an integer of 3 or 4, or formula (II):

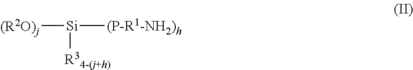

wherein

P is a (co)polymer chain of a conjugated diolefin or a conjugated diolefin and an aromatic vinyl compound;

R¹ is an alkylene group having 1 to 12 carbon atoms;

each R² and R³ is independently an alkyl group having 1 to 20 carbon atoms, an allyl group or an aryl group having 6 to 12 carbon atoms; and

j and h are each an integer, where j is an integer of 1 to 3, and h is an integer of 1 to 3, with the proviso that j+h is an integer of 2 to 4.

The terminating agent having a protected primary amino group and an alkoxysilyl group may be any compound of formula III:

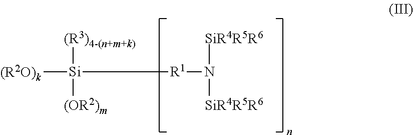

wherein

R¹ is an alkylene group having 1 to 12 carbon atoms;

each R² and R³ is independently an alkyl group having 1 to 20 carbon atoms, an allyl group or an aryl group;

each occurrence of R⁴, R⁵ and R⁶ is independently an alkyl group having 1 to 12 carbon atoms or aryl group of from 6 to 12 carbon atoms, with the proviso that R⁴ and R⁵ may combine through a covalent bond with each other to form a ring together with silicon atoms to which they are bonded;

k, m and n are each an integer, where n is 1 or 2, m is 1 or 2, and k is 1 or 2, with the proviso that n+m+k is an integer of 3 or 4, or of formula (IV):

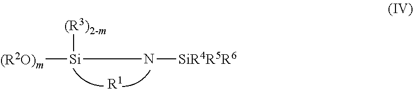

wherein

R¹ is an alkylene group having 1 to 12 carbon atoms;

each R² and R³ is independently an alkyl group having 1 to 20 carbon atoms, an allyl group or an aryl group;

each occurrence of R⁴, R⁵ and R⁶ is independently an alkyl group having 1 to 12 carbon atoms or aryl group of from 6 to 12 carbon atoms, with the proviso that R⁴ and R⁵ may combine through a covalent bond with each other to form a ring together with silicon atoms to which they are bonded;

m is 1 or 2.

The terminating agent is a compound having a protected primary amino group and an alkoxysilyl group may be any of various compounds as are known in the art. In an aspect, the terminating agent is a compound having a protected primary amino group and an alkoxysilyl group may include, for example, N,N-bis(trimethylsilyl)aminopropyl-methyldimethoxysilane, 1-trimethylsilyl-2,2-dimethoxy-1-aza-2-silacyclopentane, N,N-bis (trimethylsilyl)aminopropyltrimethoxysilane, N,N-bis-(trimethylsilyl)aminopropyl-triethoxysilane, N,N-bis (trimethylsilyl)aminopropylmethyldiethoxysilane, N,N-bis-(trimethylsilyl)aminoethyltrimethoxysilane, N,N-bis-(trimethylsilyl)-aminoethyltriethoxysilane, N,N-bis-(trimethylsilyl)aminoethylmethyldimethoxysilane and N,N-bis-(trimethylsilyl)aminoethylmethyldiethoxysilane. More specifically, the terminating agent 1-trimethylsilyl-2,2-dimethoxy-1-aza-2-silacyclopentane, N,N-bis-(trimethylsilyl)amino-propylmethyldimethoxysilane or N,N-bis-(trimethylsilyl)aminopropylmethyldiethoxysilane.

By appropriate post-treatment to yield a primary amine, it is meant that after the reaction of the living polymer with the compound having a protected primary amino group and an alkoxysilyl group, the protecting groups are removed. For example, in the case of bis-(trialkylsilyl) protecting groups, as in N,N-bis(trimethylsilyl)aminopropyltriethoxysilane, hydrolysis is used to remove the trialkylsilyl groups and leave the primary amine.

In another aspect, the solution polymerized of styrene and butadiene monomers and functionalized with an alkoxysilane group and a thiol, as disclosed in WO Publication No. 2007/047943, the entire contents of which is incorporated herein by reference. The diene based polymer containing at least one functional group (i)(a) has the formula (V):

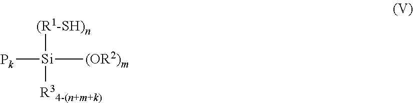

wherein

P is a (co)polymer chain of a conjugated diolefin or a conjugated diolefin and an aromatic vinyl compound,

R¹ is an alkylene group having 1 to 12 carbon atoms;

each R² and R³ is independently an alkyl group having 1 to 20 carbon atoms, an allyl group or an aryl group; and

k, m and n are each an integer, where n is 1 or 2, m is 1 or 2, and k is 1 or 2, with the proviso that n+m+k is an integer of 3 or 4.

The reaction product having formula (V) is prepared from the reaction of a living anionic polymer and a silane-sulfide terminating agent (modifier) having the formula (VI):

(R²O)_{b}R³_{4-(n+b)}Si—[R¹S—SiR⁴R⁵R⁶]ₙ (VI)

wherein

R¹ is an alkylene group having 1 to 12 carbon atoms;

each occurrence of R² and R³ is independently an alkyl group having 1 to 20 carbon atoms, an allyl group or an aryl group;

each occurrence of R⁴, R⁵ and R⁶ is independently an alkyl group having 1 to 12 carbon atoms or aryl group of from 6 to 12 carbon atoms, with the proviso that R⁴ and R⁵ may combine through a covalent bond with each other to form a ring together with silicon atoms to which they are bonded; and

n and b are each an integer, where n is 1 or 2, b is 1, 2 or 3, with the proviso that n+b is an integer of 2 to 4.

The protecting group is removed by any reaction that generates a free thiol group, such as hydrolysis or transesterification.

Representative and non-limiting examples of compounds of formula (V) include (CH₃O)₃Si—(CH₂)₃—S—Si(CH₃)₃, (CH₃CH₂O)₃Si—(CH₂)₃—S—Si(CH₃)₃, (CH₃CHO)₃Si—(CH₂)₂—S—Si(CH₃)₃, (CH₃CH₂O)₃Si—CH₂—S—Si(CH₃)₃, (CH₃CH₂O)₃Si—CH₂CH(CH₃)CH₂—S—Si(CH₃)₃, (CH₃CH₂O)₂(CH₃)Si—(CH₂)₃—S—Si(CH₃)₃, (CH₃CH₂CH₂O)₃Si—CH₂—S—Si(CH₃)₂C(CH₃)₃, (CH₃O)₃Si—CH₂—C(CH₃)₂—CH₂—SSi(CH₃)₂C(CH₃)₃, (CH₃CH₂O)₃Si—CH₂C(CH₃)₂CH₂—S—Si(CH₃)₂C(CH₃)₃ and (CH₃CH₂O)₃Si—CH₂C(CH₃)₂CH₂—S—Si(CH₃)₂C(CH₃)₃.

In an aspect, the living anionic elastomeric polymer is selected from the group consisting of homopolymers of isoprene, homopolymers of butadiene, copolymers of butadiene with styrene, copolymers of isoprene with styrene, terpolymers butadiene with isoprene and styrene, and combinations thereof.

In another aspect, the living anionic elastomeric polymer is selected from the group consisting of homopolymers of butadiene and copolymers of butadiene with styrene.

Monomers useful in preparing the diene based polymers (i) include conjugated olefins and olefins chosen from the group comprising α-olefins, internal olefins, cyclic olefins, polar olefins and nonconjugated diolefins.

Suitable conjugated unsaturated monomers are specifically conjugated dienes, such as 1,3-butadiene, 2-alkyl-1,3-butadiene, in particular, isoprene (2-methyl-1,3-butadiene), 2,3-dimethyl-1,3-butadiene, 1,3-pentadiene, 2,4-hexadiene, 1,3-hexadiene, 1,3-heptadiene, 1,3-octadiene, 2-methyl-2,4-pentadiene, cyclopentadiene, 2,4-hexadiene, 1,3-cyclooctadiene. Alpha-olefins including, but not limited to, long chain macromolecular alpha-olefins, more especially an aromatic vinyl compound. Aromatic vinyl compounds include styrene, alkyl substituted styrene, such as 2-methylstyrene, 3-methylstyrene, 4-methylstyrene, 2,4-dimethylstyrene, 2,4,6-trimethylstyrene, stilbene, 2,4-diisopropylstyrene, 4-tert-butylstyrene, vinyl benzyl dimethylamine, (4-vinylbenzyl)dimethyl aminoethyl ether, N,N-dimethylaminoethyl styrene, tert-butoxystyrene, vinylpyridine, and mixtures thereof.

Suitable polar olefins included acrylonitrile, methacrylates, methylmethacrylate. Suitable nonconjugated olefins include diolefins having from 4 to 20 carbon atoms, especially norbomadiene, ethylidenenorbomene, 1,4-hexadiene, 1,5-hexadiene, 1,7-octadiene, 4-vinylcyclohexene, divinylbenzene including 1,2-divinylbenzene, 1,3-divinylbenzene and 1,4-divinylbenzene and mixtures thereof.

Preferred conjugated dienes include 1,3-butadiene, isoprene and cyclopentadiene, and preferred aromatic alpha-olefins include styrene and 4-methylstyrene.

Non-limiting examples diene based polymers (i)(a) include homopolymers of conjugated dienes, especially butadiene or isoprene, and random or block co- and terpolymers of at least one conjugated diene, especially butadiene or isoprene, with at least one aromatic alpha-olefin, especially styrene and 4-methylstyrene, aromatic diolefin, especially divinylbenzene. Especially preferred is the random copolymerization, optionally terpolymerization, of at least one conjugated diene with at least one aromatic alpha-olefin and/or aliphatic alpha-olefin, especially butadiene or isoprene with styrene and/or 4-methylstyrene.

In general, the polymerization of the diene monomer(s) or copolymerization of the diene monomer(s) with the alpha-olefin monomer(s) may be accomplished at conditions well known in the art for anionic living type polymerization reactions, such as temperatures from about −50 to about 250° C., preferably from about 0 to about 120° C. The reaction temperature may be the same as the polymerization initiation temperature. The polymerization can be effected at atmospheric pressure, at sub-atmospheric pressure, or at elevated pressures of up to, or even higher than, 500 MPa, continuously or discontinuously. Preferably, the polymerization is performed at pressures from about 0.01 to about 500 MPa, most preferably from about 0.01 to about 10 MPa, and in particular from about 0.1 to about 2 MPa. Higher pressures may be applied. In such a high-pressure process, the initiator can also be used with good results.

Solution polymerizations normally take place at lower pressures, preferably below about 10 MPa. The polymerization can be carried out in the gas phase as well as in a liquid reaction medium. The polymerization is generally conducted under batch, continuous or semi-continuous polymerization conditions. The polymerization process can be conducted as a gas phase polymerization, as for example, in a fluidized bed or stirred bed reactor, as a solution polymerization, wherein the polymer formed is substantially soluble in the reaction mixture, a suspension/slurry polymerization, wherein the polymer formed is substantially insoluble in the reaction medium or as a so-called bulk polymerization process, in which an excess of monomer to be polymerized is used as the reaction medium.

Polymerization of the aforementioned monomers is typically initiated with an anionic initiator, such as, but not limited to, an organo metal compound having at least one lithium, sodium, potassium or magnesium atom, the organo metal compounds containing from 1 to about 20 carbon atoms. Preferably the organo metal compound has at least one lithium atom, such as for example, ethyl lithium, propyl lithium, n-butyl lithium, sec-butyl lithium, tertbutyl lithium, phenyl lithium, hexyl lithium, 1,4-dilithio-n-butane, 1,3-di(2-lithio-2-hexyl)benzene, and preferably n-butyl lithium and sec-butyl lithium. These organo lithium initiators may be used alone or in combination as a mixture of two or more different kinds.

The amount of organo lithium initiator used varies based upon the monomers being polymerized and on the target molecular weight of the produced polymer; however, the amount is typically about 0.1 to about 5 mmol, preferably about 0.3 to about 3 mmol per 100 grams of monomer, where the 100 grams of monomer are the total polymerizable monomer.

Polar coordinator compounds may be optionally added to the polymerization mixture to adjust the microstructure, such as the content of vinyl bond, of the conjugated diolefin portion of the diolefin-type homo-, copolymer or terpolymer, or to adjust the composition distribution of the aromatic vinyl compound in the conjugated diene monomer containing co- or terpolymer, and thus, for example, to serve as randomizer component. Polar coordinator compounds are, for example, but not limited to, ether compounds, such as diethyl ether, di-n-butyl ether, ethylene glycol diethyl ether, ethylene glycol dibutylether, diethylene glycol dimethyl ether, propylene glycol dimethyl ether, propylene glycol diethyl ether, propylene glycol dibutylether, alkyltetrahydrofuryl ethers, such as, methyltetrahydrofurylether, ethyltetrahydrofurylether, propyltetrahydrofurylether, butyltetrahydrofurylether, hexyltetrahydrofurylether, octyltetrahydrofurylether, tetrahydrofuran, 2,2-(bis-tetrahydrofurfuryl)propane, bis-tetrahydrofurfurylformal, methyl ether of tetrahydrofurfuryl alcohol, ethyl ether of tetrahydrofurfuryl alcohol, butyl ether of tetrahydrofurfuryl alcohol, alpha-methoxytetrahydrofuran, dimethoxybenzene, and/or dimethoxyethane and/or tertiary amine compounds such as butyl ether of triethylamine, pyridine, N,N,N′,N′-tetramethyl ethylenediamine, dipiperidinoethane, methyl ether of N,N-diethylethanolamine, ethyl ether of N,N-diethylethanolamine, and/or N,N-diethylethanolamine.

The polar coordinator compound will typically be added at a molar ratio of the polar coordinator compound to the lithium initiator within the range of about 0.012:1 to about 5:1, but typically about 0.1:1 to about 4:1, preferably about 0.25:1 to about 3:1, and more preferably about 0.5:1 to about 3:2.

The polymerization can optionally be conducted utilizing an oligomeric oxolanyl alkane as a polar coordinator compound. Examples of such compounds are provided in U.S. Pat. Nos. 6,790,921 and 6,664,328, each of which is incorporated herein by reference.

The polymerization can optionally include accelerators to increase the reactivity of the initiator, to randomly arrange, aromatic vinyl compounds introduced in the polymer, or to provide a single chain of aromatic vinyl compounds, and thus influencing the composition distribution of the aromatic vinyl compounds in a diene based polymer (i).

Examples of applicable accelerators include sodium and potassium alkoxides or potassium phenoxides, such as potassium isopropoxide, potassium t-butoxide, potassium t-amyloxide, potassium n-heptyloxide, potassium benzyloxide, potassium phenoxide; potassium salts of carboxylic acids such as isovalerianic acid, caprylic acid, lauryl acid, palmitic acid, stearic acid, oleic acid, linolenic acid, benzoic acid, phthalic acid, or 2-ethylhexanoic acid; potassium salts of organic sulfonic acids such as dodecyl benzenesulfonic acid, tetradecyl benzenesulfonic acid, hexadecyl benzenesulfonic acid, or octadecyl benzenesulfonic acid; and potassium salts of organic phosphorous acids such as diethyl phosphite, diisopropyl phosphite, diphenyl phosphite, dibutyl phosphite, and dilauryl phosphite. These potassium compounds may be added in an amount of about 0.005 to about 0.5 mole for 1.0 gram atom equivalent of lithium initiator. If less than 0.005 mole are added, a sufficient effect is not typically achieved. On the other hand, if the amount of the potassium compound is more than 0.5 mole, the productivity and efficiency of chain end modification reaction is significantly reduced.

An alkali metal alkoxide compound may also be added together with the polymerization initiator to increase the polymerization reactivity. The alkali metal alkoxide compound can be prepared by reacting an alcohol and an organic alkali metal compound. This reaction may be carried out in a hydrocarbon solvent in the presence of monomers, preferably conjugated diolefin monomers and aromatic vinyl compound monomers prior to the copolymerization of these monomers.

Alkali metal alkoxide compound are exemplary represented by metal alkoxides of tetrahydrofurfuryl alcohol, N,N-dimethyl ethanolamine, N,N-diethyl ethanolamine, 1-piperazine ethanolamine, or the like. An organic alkali metal compound preferably may be an organolithium compound, and can be used as reactant for an alcohol compound to prepare an alkali metal alkoxide. For example, ethyl lithium, propyl lithium, n-butyl lithium, sec-butyl lithium, tert-butyl lithium, and hexyl lithium, and mixtures of these can be given. Of these, n-butyl lithium and sec-butyl lithium are preferable. The molar ratio of an alcoholic compound and an organolithium compound should be from about 1:0.7 to about 1:5.0, preferably from about 1:0.8 to about 1:2.0, and more preferably from about 1:0.9 to about 1:1.2. If the molar ratio of an organolithium compound to an alcoholic compound is more than 5.0, the effect on improvement of tensile strength, abrasion resistance, and hysteresis is compromised. On the other hand, a molar ratio of the organolithium compound smaller than 0.8 retards the speed of polymerization and significantly decreases productivity giving rise to low efficiency of the chain end modification reaction.

To further control polymer molecular weight and polymer properties, a coupling agent or linking agent may be employed. For example, a tin halide, a silicon halide, a tin alkoxide, a silicon alkoxide, or a mixture of the aforementioned compounds, can be continuously added during the polymerization, in cases where asymmetrical coupling is desired.

This continuous addition is normally done in a reaction zone separate from the zone where the bulk of the polymerization is occurring. The coupling agent can be added in a hydrocarbon solution, for example, cyclohexane, to the polymerization admixture with suitable mixing for distribution and reaction. The coupling agent will typically be added only after a high degree of conversion has already been attained. For instance, the coupling agent will normally be added only after a monomer conversion of greater than 85 percent has been realized. It will typically be preferred for the monomer conversion to reach at least 90 percent before the coupling agent is added.

Common halide coupling agents include tin tetrachloride, tin tetrabromide, tin tetrafluoride, tin tetraiodide, silicon tetrachloride, silicon tetrabromide, silicon tetrafluoride, silicon tetraiodide, tin and silicon trihalides or tin and silicon dihalides can also be used. Polymers coupled with tin or silicon tetrahalides have a maximum of four arms (or four coupled polymer chains), tin and silicon trihalides have a maximum of three arms and tin and silicon dihalides have a maximum of two arms. Hexahalo disilanes or hexahalo disiloxanes can also be used as coupling agents resulting in polymers with a maximum of six arms. Useful tin and silicon halides coupling agents include SnCl4, (R⁷)₃SnCl, (R⁷)₂SnCl₂, SiCl₄, (R⁷)₃SiCl, (R⁷)₂SiCl₂, R⁷SiCl³, Cl₃Si—SiCl₃, Cl₃Si—O—SiCl₃, Cl₃Sn—SnCl₃, Cl₃Sn—O—SnCl₃, where R⁷ is an alkyl group of from 1 to 12 carbon atoms.

Examples of tin and silicon alkoxides coupling agents include Si(OCH₃)₄, Sn(OCH₃)₄, Sn(OCH₂CH₃)₄ or Si(OCH₂CH₃)₄. The most preferred coupling agents are SiCl₄, Sn(OCH₃)₄ and Si(OCH₃)₄.

A combination of a tin or silicon compound can optionally be used to couple the polymer. By using such a combination of tin and silicon coupling agents, improved properties for the diene based polymer (i)(a) used in tires, such as lower hysteresis, can be attained.

It is particularly desirable to utilize a combination of tin and silicon coupling agents in tire tread compounds that contain both silica and carbon black. In such cases, the molar ratio of the tin to the silicon compound employed in coupling the diene based polymer (i)(a) will normally be within the range of about 20:80 to about 95:5; more typically about 40:60 to about 90:10, and preferably about 60:40 to about 85:15. Most typically, a range of about 0.01 to about 4.5 milliequivalents of coupling agent (tin and silicon compound) is employed per 100 grams of the diene based polymer (i)(a). It is normally preferred to utilize about 0.01 to about 1.5 milliequivalents of the coupling agent per 100 grams of the diene based polymer (i)(a) to obtain the desired Mooney viscosity. The larger quantities tend to produce polymers containing terminally reactive groups or insufficient coupling. Between zero and less than one equivalent of tin and/or silicon coupling group per equivalent of lithium initiator is used to enable subsequent functionalization of the remaining living polymer fraction. For instance, if a tin or silicon tetrachloride, or a mixture of these compounds, is used as the coupling agent, between 0 and less than 1.0 mole, preferably between 0 and about 0.8 mol, and more preferably between 0 and about 0.6 mole, of the coupling agent is utilized for every 4.0 moles of live lithium polymer chain ends.

The coupling agent can be added in a hydrocarbon solution, such as in cyclohexane, to the polymerization admixture in the reactor with suitable mixing for distribution and reaction.

For solution based polymerization processes, the polymerization is conducted in a suitable solvent, dispersion agents or diluent. Non-coordinating, inert liquids are preferred, including, but not limited to, straight and branched-chain hydrocarbons, such as propane, butane, isobutane, pentane, hexane, heptane, octane, cyclic and alicyclic hydrocarbons, such as cyclohexane, cycloheptane, methylcyclohexane, methylcycloheptane, aromatic and alkyl-substituted aromatic compounds, such as benzene, toluene, and xylene, and isomers of the foregoing, and mixtures thereof, as well as pentamethyl heptane or mineral oil fractions, such as light or regular petrol, naphtha, kerosene or gas oil. Fluorinated hydrocarbon fluids, such as perfluorinated alkanes containing for 4 to 10 carbon atoms are also suitable.

Further, suitable solvents, including liquid olefins, which may act as monomers or comonomers in the polymerization process, including propylene, 1-butene, 1-pentene, cyclopentene, 1-hexene, 3-methyl-1-pentene, 4-methyl-1-pentene, butadiene, isoprene, 1,4-hexadiene, 1,7-octadiene, 1-octene, 1-decene, styrene, divinylbenzene, ethylidenenorbomene, allylbenzene, 2-methylstyrene, 3-methylstyrene, 4-methylstyrene, 4-vinylcyclohexene, and vinylcyclohexane.

Mixtures of the solvents are also suitable. Aromatic hydrocarbons, for instance benzene and toluene, can also be used.

Suitable diene based polymers containing at least one functional group (i)(a), where the functional group is an alkoxysilane group and a thiol group are available commercially, such as from Dow Olefinverbund GmbH, which are of the type described in WO Publication No. 2007/047943, the entire contents of which is incorporated herein by reference.

The diene based polymer containing at least one functional group (i)(a) can be prepared in accordance with U.S. Patent Publication No. 2013/0165578 A1, the entire contents of which is incorporated herein by reference. Suitable diene based polymers containing at least one functional group (i)(a) are in-chain functionalized polybutadiene elastomer, which comprises a copolymer of in-chain repeat units derived from 1,3-butadiene monomer and a functionalized monomer in amount of from about 0.2 to about 1.5 weight percent, based on the total weight of the monomers (1,3-butadiene monomer and, optionally, styrene monomers and isoprene monomers). The functionalized monomer has the structure of formula (VII):

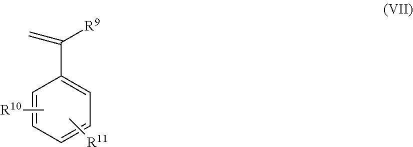

wherein

R⁹ is hydrogen or an alkyl group of from 1 to 4 carbon atoms; R¹⁰ is an functional group having formula (VIII):

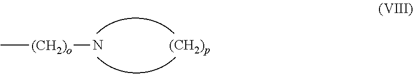

wherein p and o are each an integer, where p is 2 to 10 and o is 0 to 10, or having formula (IX):

—(CH₂)_{g}NR¹²₂ (IX)

wherein

each R¹² is independently an alkyl group of from 1 to 10 carbon atoms, an aryl group of from 6 to 10 carbon atoms or where the R¹² group is bonded to the second R¹² group through an oxygen atom to form a —(CH₂)_{q}O—(CH₂)ᵣ— group bonded to the nitrogen atom, where q and r are each an integer, where q is from 1 to 10 and r is from 1 to 10; and g is an integer from 0 to 10.

Representative and non-limiting examples of functionalized monomers include pyrrolidine ethyl styrene, vinyl benzyl pyrrolidine, vinyl benzyl dimethylamine.

In an aspect, the in-chain functionalized polybutadiene comprises repeat units derived from 1,3-butadiene and/or isoprene and at least one of pyrrolidine ethyl styrene, vinyl benzyl dimethylamine and vinyl benzyl pyrrolidine. The repeat units of isoprene may, for example, constitute from 0 to about 25, more specifically from about 2 to about 15 weight percent, the weight percent based on the total weight of the copolymer.

In an aspect, the functionalized polybutadiene rubber is a copolymer of 1,3-butadiene and functionalized monomer prepared by anionic copolymerization of the 1,3-butadiene and functional monomers in a hydrocarbon solvent in the presence of a polymerization initiator comprised of n-butyllithium to initiate the copolymerization, and optionally, a polymerization modifier to promote incorporation and/or distribution of the functional monomer units along the polybutadiene chain. The polymerization modifier is, for example and not limited to, tetramethylethylenediamine.

In another aspect, the diene based polymers containing at least one functional group (i)(a) comprises a cis 1,4-isomeric content in a range of from about 30 to about 50 percent, a trans 1,4-isomeric content in a range of from about 40 to about 60 percent and a vinyl content in a range of from about 5 to about 20 percent with a glass transition temperature (Tg) in a range of from about −85° C. to about −95° C., and an number average molecular weight (Mn), may be for example, in a range of from about 75,000 to about 350,000 and its dispersivity of weight average to number average (Mw/Mn) may be in a range, for example, of from about 1 to about 2.5, alternately from about 1.5 to about 2.5, as prepared in accordance with U.S. Pat. No. 6,664,328, which is incorporated in its entirety herein by reference. The number average molecular weight and weight average molecular weight are determined in accordance with ASTM D6474-20, Standard Test Method for Determining Molecular Weight Distribution and Molecular Weight Averages of Polyolefins by High Temperature Gel Permeation Chromatography.

The diene based polymer containing at least one functional group (i)(a) includes polymers where the functional group reacts with at least one silicic acid functional group to form a silicic acid functionalized polymer, as disclosed in DE 102013100009A1, the entire contents of which therein are incorporated by reference. In particular, a solution polymerized diene based polymer containing at least one functional group (i)(a) reacts with a silicic acid to form a silicic acid functionalized styrene-butadiene polymer. These diene based polymers (i)(a) show a positive influence on the abrasion behavior.

In an aspect, the silicic acid-functionalized styrene-butadiene polymer has a vinyl content of from about 10 to about 80 percent by weight, more preferably from about 10 to about 70 percent by weight and a styrene content of from 0 to about 50 percent by weight, particularly preferably from 0 to about 35 percent by weight, where the weight percentages are based on the total weight of the diene based polymer (i)(a).

The functionalization of silica hereby takes place by reaction with the hydroxyl groups, epoxy groups, siloxane groups, phthalocyanine groups, amino siloxane groups and/or with carboxy groups. The functional groups include —OH, —COOH, —COCl, —SH, —CSSH, —NCO, amino, epoxy, silyl, silanol or siloxane groups, including polysiloxane. Siloxane groups are attached to the diene based polymer chain with or without a linking group.

The silyl, silanol and siloxane groups are -ASiH₂(OH), -ASi (R¹³)₂(OH),-ASiH(OH)₂, -ASiR¹³(OH)₂, -ASi(OH)₃, -ASi(OR¹³)₃, -A(SiR¹³R¹⁴O)ᵤ—R¹⁵, -ASi(R¹⁵)₃ or -ASi(A^{L}N(R¹⁵)₂)ᵥ(OR¹³)_{w}(R¹⁵)_{3-(v+w)}, wherein each occurrence of R¹³ and R¹⁴ is independently an alkoxy group, linear alkyl containing from 1 to 12, a branched alkyl group containing from 3 to 12 carbon atoms, cycloalkyl group containing from 5 to 12 carbon atoms, an aryl group containing from 6 to 12 carbon atoms, alkylaryl group containing from 7 to 12 carbon atoms, an aralkyl group containing from 7 to 12 carbon atom or vinyl, each R¹⁵ is independently linear alkyl containing from 1 to 12, a branched alkyl group containing from 3 to 12 carbon atoms, cycloalkyl group containing from 5 to 12 carbon atoms or hydrogen, each u, v and w is an integer, wherein u is from 1 to 1500, v is from 0 to 3, w is from 0 to 3, with the proviso that v+w is less than or equal to 3; and each occurrence of A and A¹ is alkylene group of from 1 to 12 carbon atoms or a covalent single bond.

An aspect includes a diene based polymer (i) having a number average molecular weight prior to functionalization with silicic acid of about 150,000 to about 400,000, more specifically of about 200,000 to about 300,000, and even more specifically of about 225,000 to about 275,000. The diene based polymer (i)(a) which at least one terminal functional group includes styrene butadiene copolymers, butadiene homopolymer having a cis-1,4 bond content of 90 percent or more, a syndiotactic-1,2-polybutadiene, isoprene rubber, styrene-isoprene copolymer or butadiene-isoprene copolymer.

As a diene based polymer with terminal functional groups (i)(a), the functional group can be derived from various compounds, specifically, tin compounds, aminobenzophenone compounds, isocyanate compounds, diglycidyl amine compounds, cyclic imine compounds, alkoxysilane halide compounds, glycidoxy propylalkoxysilane compounds, and neodymium compounds.

The living diene base polymer used to prepare the diene based polymer with at least one functional group (i)(a) has a number average molecular weight (Mn) of the polymer prior to functionalization is about 150,000 to about 400,000, and more preferably about 150,000 to about 250,000. When the Mn is less than 150,000, a sufficient strength cannot be exerted. Conversely, when the Mn exceeds about 400,000, the diene based polymer (i)(a) is inferior in the effect of improving the low fuel consumption property. In addition, when the diene based polymer (i)(a) are bonded to each other due to the terminal functional group, resulting in a two-fold or three-fold molecular weight, the processing thereof is difficult to carry out. The number average molecular weight and weight average molecular weight are determined in accordance with ASTM D6474-20, Standard Test Method for Determining Molecular Weight Distribution and Molecular Weight Averages of Polyolefins by High Temperature Gel Permeation Chromatography.

To prepare a diene based polymer (i)(a) containing a silicic acid functionalization, a conjugate diene compound or a vinyl-substituted aromatic compound is copolymerized in the presence of an organic lithium initiator. A conjugate diene polymer and a copolymer comprising the conjugate diene compound and the vinyl-substituted aromatic compound thus obtained have an initial weight average molecular weight ranging from about 1,000 to about 300,000 as measured by ASTM D6474-20. The conjugate diene polymer or the conjugate diene copolymer may have a weight average molecular weight in the range from about 1,000 to about 1,200,000, and more specifically from about 10,000 to about 500,000.

An organic lithium initiator is used as a polymerization initiator. The organic lithium initiator is a hydrocarbon compound having at least one lithium atom, the specific examples of which may include ethyl lithium, propyl lithium, n-butyl lithium, sec-butyl lithium, tert-butyl lithium, phenyl lithium, prophenyl lithium, hexyl lithium, 1,4-dilithio-n-butane and 1,3-di(2-lithio-2-hexyl)benzene, preferably n-butyl lithium and sec-butyl lithium. These organic lithium initiators may be used alone or in combination as a mixture of two or more different kinds.

The amount of the organic lithium initiator, although variable depending on the target molecular weight of the produced polymer, is typically about 0.1 to about 5 mmole, preferably about 0.3 to about 4 mmole per 100 grams of the total weight of the monomers used.

Non-limiting examples of a hydrocarbon solvent for polymerization as used herein include n-butane, iso-pentane, n-hexane, n-heptane, iso-octane, cyclohexane, methylcyclopentane, benzene and toluene, preferably n-hexane, n-heptane and cyclohexane. The hydrocarbon solvent is used in an amount of from about 0.1 to about 25 parts by weight per one part by weight of the monomer, more specifically in an amount of about 1 to about 20 parts by weight per one part by weight of the monomer, and even more specifically from about 5 to about 15 parts by weight per one part by weight of the monomer.

Suitable conjugate diene compound include isoprene and 1,3-butadiene, and suitable the vinyl-substituted aromatic compound include styrene and alpha-methyl styrene. The diene based polymer (i)(a) may include from about 10 to 100 percent by weight of the conjugate diene monomer and from 0 to about 90 percent by weight of the vinylsubstituted aromatic monomer, more specifically from from about 20 to about 80 percent by weight of the conjugate diene monomer and from about 20 to about 80 percent by weight of the vinylsubstituted aromatic monomer, and even more specifically from about 30 to about 50 percent by weight of the conjugate diene monomer and from about 50 to about 70 percent by weight of the vinylsubstituted aromatic monomer, based on the total weight of the monomer used.

The end of the living diene polymer is then reacted in the presence of a coupling agent, which is an organic compound, where the coupling agent possess a group, such as a hydrolyzable silyl group, capable of reacting with the carbanion of the living polymer.

An aspect is the diene based polymer (i)(a), in which both terminals contain the functional group. These diene based polymers (i)(a) are prepared in accordance with U.S. Pat. No. 9,328,176 B2, the entire contents of which are incorporated herein by reference.

The difunctional initiator may be made available by a common method describing that a mono organo-lithium initiator is added to a reactor in the presence of a non-polar hydrocarbon solvent and a polar additive, followed by a slow addition of a divinyl aromatic material to this solution. For the preparation of a difunctional initiator, the examples of divinyl aromatic material selected from the group consisting of 1,3-divinylbenzene, 1,4-divinylbenzene, 1,3-diisopropenylbenzene, 1,3-dipropenylbenzene, 1,4-diisopropenylbenzene, 2,4-diisopropenyltoluene, 2,4-divinyltoluene, 1,3-distyrylbenzene, 1,4-distyrylbenzene, 1,2-distyrylbenzene, 1,3-diisobutenylbenzene and 1,3-diisopentenylbenzene; among these compounds, it is most preferred to select 1,3-diisopropenylbenzene.

Non-limiting examples of an organo-lithium initiator include n-butyl lithium, sec-butyl lithium and t-butyl lithium; it is preferred that 2 to 2.5 equivalents of t-butyl lithium are employed in proportion to the 1 equivalent of the divinyl aromatic material.

Further, a non-polar hydrocarbon solvent may be employed individually or as a mixture of cyclic aliphatic hydrocarbon solvents such as cyclohexane or cyclopentane, or aliphatic hydrocarbon solvents such as n-hexane or n-heptane; among these compounds, it is most preferred to select cyclohexane.

The examples of a polar additive include dialkyl ether, cyclic ether and trialkyl amine. The polar additive is employed in a range of about 0.3 to about 2.0 equivalents in proportion to 1 equivalent of the lithion ion of an organolithium initiator, and more specifically in the range of about 0.5 to about 1.5 equivalents. It is preferred that triethylamine is employed in the range of about 0.5 to about 1.5 equivalents in proportion to 1 equivalent of lithium ion of an organolithium initiator, and more preferably in the range of about 0.7 to about 1.2 equivalents.

The first-step reaction for preparing a difunctional initiator is performed at the temperature of about −40 to about 40° C. for about 1 to about 10 hours, more preferably at the temperature of about −40 to about 20° C. for about 1 to about 3 hours. The second-step reaction is that a difunctional initiator, so prepared, is added to a conjugated diene-aromatic vinyl monomer in the presence of a non-polar hydrocarbon solvent and a polar additive to activate one terminal of a difunctional initiator, thus synthesizing a random copolymer.

The preferred examples of non-polar hydrocarbon solvents include cyclohexane, n-hexane and n-heptane, or its mixture. Cyclic ether and dialkyl ether is employed as a randomizer in the range of 0.2 to 5 weight percent, which is most preferred.

Further, a conjugated diene monomer of 4 to 8 carbon atoms may be selected from the group consisting of 1,3-butadiene, 2-methyl-1,3-butadiene, 1,3-pentadiene or 1,3-hexadiene. The non-limiting examples of an aromatic vinyl monomer includes styrene or alpha-methyl styrene.

The second-step reaction is performed at the temperature of about −40 to about 70° C. until the conversion of monomer to polymer is more than 90 percent. It is preferred to perform the reaction up to conversion of more than 95 percent and the most preferred to perform up to the conversion more than 99 percent. In a random copolymer which is prepared via the second step reaction, it is preferred that its styrene content is in the range of about 10 to about 30 weight percent, more preferably in the range of about 15 to about 25 weight percent. Further, the vinyl content is in the range of about 40 to about 70 weight percent, more preferably in the range of about 40 to about 50 weight percent. The final third-step reaction is that a polar material is added to a random polymer and then, an electrophilic material is added to the active sites of the polymer at both terminals, thus forming a polymer having functional groups at both terminals.

Ethers and tertiary amines can be used as a polar material. The detailed examples of the polar material include diethyl ether, di-n-propyl ether, diisopropyl ether, di-n-butyl ether, tetrahydrofuran, dioxane, ethylene glycol dimethyl ether, ethylene glycol diethyl ether, diethylene glycol dimethyl ether, diethylene glycol diethyl ether, triethylene glycol dimethyl ether, trimethylamine, triethylamine, N′,N,N′,N′-tetramethylethylene diamine and N,N,N′,N′,N″-pentamethydiethylene triamine. Less than 100 equivalents of the polar material may be used in proportion to 1 equivalent of lithium ion, most preferably in less than 10 equivalents.

Further, the examples of an electrophilic material which is added in both terminals of polymer include amino ketones, amino aldehydes, thioaminoketone, thioaminoaldehyde and amides. The electrophilic material is added to a polymer in the range of about 0.5 to about 3 equivalents in proportion to 1 equivalent of lithium ion. In particular, it is most preferred that in the cases of 4-dimethylaminobenzopheonone, 4-diethylaminobenzopheonone or 4,4′-bis-(diethylamino)benzopheonone, about 0.8 to about 1.5 equivalents are employed in proportion to 1 equivalent of lithium ion.

The third-step reaction is performed at the temperature of about −40 to about 80° C. for about 1 to about 6 hours, and more specifically at the temperature of about 60 to about 80° C. for about 1 to about 2 hours.

The applicable weight average molecular weight of a random copolymer which is prepared from the three-step reactions, is in the range of about 100,000 to about 500,000, preferably in the range of about 200,000 to about 400,000.

An aspect is to provide a diene based polymer containing at least one functional group (i)(a), where the polymer is prepared by radical polymerization of a styrene monomer, a butadiene monomer and an epoxy acrylate monomer in emulsion state and ring-opening the styrene-butadiene-epoxy acrylate copolymer. These diene based polymer containing at least one functional group (i)(a) are prepared in accordance with U.S. Pat. No. 9,328,176 B2, the entire content of which is incorporated herein by reference. These diene based polymers contribute to wet braking performance and wear resistance when blended with silica.

Among the monomers used in the polymerization reaction, the styrene monomer may be one or more selected from styrene, methylstyrene and dimethylstyrene, and is used in an amount of about 10 to about 50 weight percent and more specifically of about 20 to about 40 weight percent, based on the weight of the total monomers. If it is used in an amount less than 10 weight percent, the tensile property and other mechanical properties may be degraded. Meanwhile, if it is used in an amount exceeding 50 weight percent, elasticity and wear resistance may be degraded. The butadiene monomer may be one or more selected from 1,3-butadiene and isoprene, and is used in an amount of about 45 to about 85 weight percent and more specifically about 60 to about 80 weight percent, based on the weight of the total monomers. If it is used in an amount less than 45 weight, elasticity and wear resistance may be degraded. Meanwhile, if it is used in an amount exceeding 85 weight percent, tensile property and other mechanical properties may be degraded. In a copolymer produced from the styrene monomer and the butadiene monomer, the butadiene unit may have trans or cis configuration.

The epoxy acrylate monomer may be glycidyl acrylate or glycidyl methacrylate, and is preferably used in an amount of about 0.1 to about 10 weight percent, more specifically of about 1 to about 8 weight percent and even more specifically from about 2 to about 5 weight percent, based on the weight of the total monomers. If it is used in an amount less than 0.1 weight percent, the styrene-butadiene-acrylate copolymer may have insufficient hydrophilicity. Meanwhile, if it is used in an amount exceeding 10 weight percent, processing may be difficult because of reduced elasticity and increased strength.

A radical initiator commonly used in the art may be used. The radical initiator system used in emulsion polymerization is selected from persulfates such as potassium persulfate and ammonium persulfate, acetylacetone peroxide, benzyl peroxide, dicumyl peroxide, p-menthane hydroperoxide, 2,4-dichlorobenzyl peroxide, t-butyl peracetate, 2,2′-azobis(isobutylamidine)di-hydrochloride, azobisisobutyronitrile, hydrogen peroxide, redox systems, ferrous sulfate, etc. may be used.

In the polymerization of a styrene monomer, a butadiene monomer, and an epoxy acrylate monomer, a hydroxyl functional group can participate in epoxy ring-opening. In a first step, radical polymerization of a styrene monomer, a butadiene monomer, and an epoxy acrylate monomer an emulsion state is carried out to prepare a copolymer and, in a second step, the epoxy ring is ring-opening under an acidic or alkaline conditions. As a result of the ring-opening of the epoxy ring, the copolymer has pendent esters containing 1,2-dihydroxyl propyl groups.

In the preparation of the diene base polymer (i)(a), the radical initiator is used in an amount of about 0.05 to about 3 parts by weight and more specifically of about 0.1 to about 2 parts, based on 100 parts by weight of the total monomers. If it is used in an amount less than 0.05 parts by weight, polymerization may not occur sufficiently. Meanwhile, if it is used in an amount exceeding 3 parts by weight, a low-molecular-weight copolymer may be obtained.

Further, an anionic, cationic, or non-ionic surfactant may be used as an emulsifier. The anionic surfactants may be selected from an alkyl sulfate metal salt, an alkyl allyl sulfonic acid metal salt, an alkyl phosphate metal salt, an alkyl sulfate ammonium salt, an alkyl allyl sulfonic acid ammonium salt, an alkyl aryl sulfonic acid ammonium salt, an allyl sulfonic acid ammonium salt, or an alkyl phosphate ammonium salt may be used. Specifically, metal salts or ammonium salts of dodecylbenzenesulfonic acid, rosin acids, fatty acids, lauryl sulfonic acid or hexadecylsulfonic acid may be used. Cationic surfactants include tetra-substituted ammonium halide, such as dodecyltrimethyl ammonium chloride. Non-ionic surfactants are hydroxyl-terminated hydrocarbon started polyalkene oxide polymers.

The emulsifier is used in an amount of about 0.1 to about 10 parts by weight and more specifically of about 1 to about 5 parts by weight, based on 100 parts by weight of the total monomers.

Further, in the preparation of the diene based polymer (i)(a), a mercaptan compound having 8 to 20 carbon atoms may be used as a molecular weight modifier. Preferably, one or more selected from octylmercaptan, decylmercaptan, dodecylmercaptan and hexadecylmercaptan may be used. The average molecular weight of the styrene-butadiene copolymer may be controlled by controlling the amount of the molecular weight modifier. When the mercaptan-based molecular weight modifier is used in an amount of about 0.001 to about 2 parts by weight based on 100 parts by weight of the total monomers, a high-molecular-weight styrene-butadiene copolymer may be prepared. Meanwhile, if it is used in an amount of about 0.5 to about 2 about parts by weight, a low-molecular-weight styrene-butadiene copolymer may be prepared. If the mercaptan-based molecular weight modifier is used in an amount less than 0.0001 part by weight, gelation may occur. Meanwhile, if it is used in an amount exceeding 2 parts by weight, physical properties may be degraded.

In the preparation of the diene-based polymer (i)(a), a diethylhydroxylamine, N-isopropylhydroxylamine, monoethylhydroxylamine, sodium dimethyldithiocarbamate, or the like may be used as a polymerization terminator. Preferably, the polymerization terminator may be used in an amount of about 0.01 to about 2 parts by weight and more specifically of about 0.1 to about 1 parts by weight, based on 100 parts by weight of the total monomers.

The method for preparing the diene based polymer is multistep. First, a styrene monomer, a butadiene monomer and an epoxy acrylate monomer are radical polymerized at about 0 to about 70° C. and more specifically from about 15 to about 60° C. for about 4 to about 48 hours in an emulsion state. As a result, a styrene-butadiene copolymer having an average molecular weight of about 100,000 to about 2,000,000 grams per mole and more specifically from about 200,000 to about 1,000,000 is prepared.

The epoxy group undergoes ring-opening in the presence of an acid, a base or a nucleophile such as amine, thereby improving compatibility with silica. The acid may be sulfuric acid, phosphoric acid, hydrochloric acid, acetic acid, hydrofluoric acid, or the like, and the base may be sodium hydroxide, potassium hydroxide, ammonium hydroxide or the like. Preferably, the acid or base, the ring-opening agent, is used in an amount of about 1 to about 20 parts by weight and more specifically of about 2 to about 10 parts by weight, based on 100 parts by weight of the total monomers.

The diene based polymer (i)(a) prepared by emulsion polymerization has particles in the range of from about 20 to about 2000 nanometer and has an average molecular weight of about 100,000 to about 3,000,000 grams per mole and more specifically from about 40 to about 1500 nanomether and has an average molecular weight of about 150,000 to about 2,000,000 grams per mole.

An aspect is to provide for diene based polymers containing at least one functional group (i)(a), where the functional group is a stanyl functional group. The diene based polymers containing at least one functional group (i)(a) can be prepared in accordance with U.S. Pat. No. 5,514,757, which is incorporated in its entirety herein. The anionic polymerization of the monomer is carried out as described above. The living anionic polymer is then reacted with a tin compound. Useful tin compounds include SnCl₄, (R¹⁶)₃SnCl, (R¹⁶)₂SnCl₂, SiCl₄, (R¹⁶)₃SiCl, (R¹⁶)₂SiCl₂, R¹⁶SiCl₃, Cl₃Si—SiCl₃, Cl₃Si—O—SiCl₃, Cl₃Sn—SnCl₃, Cl₃Sn—O—SnCl₃, where R¹⁶ is an alkyl group of from 1 to 12 carbon atoms, Sn(OCH₃)₄ or Sn(OCH₂CH₃)₄. The most preferred coupling agents are SiCl₄, Sn(OCH₃)₄, and Si(OCH₃)₄.

Diene Based Polymer Containing No Functional Groups (i)(b)

In some aspects, the diene based polymer may comprise a diene based polymer which does not contain a functional group.

The other rubber components that are diene based polymer which do not contain functional groups (i)(b) are suitable vulcanizable, i.e., curable, rubbers (organic polymers) are well known in the art and are described in numerous texts of which two examples are The Vanderbilt Rubber Handbook, R. F. Ohm, ed. (R.T. Vanderbilt Company, Inc., Norwalk, Conn., 1990), and Manual for the Rubber Industry, T. Kempermann, S. Koch, and J. Sumner, eds. (Bayer A G, Leverkusen, Germany, 1993), which are incorporated in their entirety herein consistent with the present disclosure.

Representative examples of suitable vulcanizable polymers include solution polymerization-prepared styrene-butadiene rubber (S-SBR), emulsion polymerization-prepared styrene-butadiene rubber (E-SBR), natural rubber (NR), polybutadiene (BR), ethylene-propylene co- and terpolymers (EP, EPDM), and acrylonitrile-butadiene rubber (NBR). The rubber composition herein is comprised of at least one diene-based elastomer, or rubber. Suitable conjugated dienes are isoprene and 1,3-butadiene and suitable vinyl aromatic compounds are styrene and alpha methyl styrene.

The diene-based polymer (i)(b), or rubber, may be selected, for example, from at least one of cis-1,4-polyisoprene rubber (natural and/or synthetic, and preferably natural rubber), emulsion polymerization-prepared styrene/butadiene copolymer rubber, organic solution polymerization-prepared styrene/butadiene rubber, 3,4-polyisoprene rubber, isoprene/butadiene rubber, styrene/isoprene/butadiene terpolymer rubber, cis-1,4-polybutadiene, medium vinyl polybutadiene rubber (35 percent to 50 percent vinyl), high vinyl polybutadiene rubber (50 percent to 75 percent vinyl), styrene/isoprene copolymers, emulsion polymerization-prepared styrene/butadiene/acrylonitrile terpolymer rubber, and butadiene/acrylonitrile copolymer rubber. Also useful are an emulsion polymerization-derived styrene/butadiene (E-SBR) having a relatively conventional styrene content of 20 percent to 28 percent bound styrene or, for some applications, an E-SBR having a medium to relatively high bound styrene content, namely, a bound styrene content of 30 percent to 45 percent. Emulsion polymerization-prepared styrene/butadiene/acrylonitrile terpolymer rubbers containing 2 to 40 weight percent bound acrylonitrile in the terpolymer are also contemplated as diene-based rubbers.

The solution polymerization-prepared SBR (S-SBR) typically has a bound styrene content in a range of about 5 to about 50 percent, preferably about 9 to about 36 percent. Polybutadiene elastomer may be conveniently characterized, for example, by having at least a 90 weight percent cis-1,4-content.

The total weight of the rubber components is the sum of the weights of each diene based polymer containing at least one functional group (i)(a) plus the sum of the weights of each diene based polymer which do not contain a functional group (i)(b). The total weight of the rubber components is set at 100 parts by weight rubber. The weights include only the weight of the diene based polymers (i)(a) and (i)(b), and not the weight of the process oil, solvents or other additives that may be blended with the polymer. Of the 100 parts by weight rubber, sum of the weights of each diene based polymer containing at least one functional group (i)(a) is from 0 to about 100 parts by weight diene based polymer (i)(a) based on 100 parts of total weight rubber (phr), more specifically from about 5 to about 100 parts by weight diene based polymer (i)(a), even more specifically from about 20 to about 90 parts by weight diene based polymer (i)(a) based on 100 parts of total weight rubber (phr), and still even more specifically from about 40 to about 80 parts by weight diene based polymer (i)(a) based on 100 parts of total weight rubber (phr), and the sum of the weight of each diene based polymer not containing functional groups (i)(b) is from 0 to about 100 parts by weight based diene based polymer (i)(b) on 100 parts of total weight rubber, more specifically from 0 to about 95 parts by weight diene based polymer (i)(b) based on 100 parts of total weight rubber, even more specifically from about 10 to about 80 parts by weight diene based polymer (i)(b) based on 100 parts of total weight rubber (phr), and still even more specifically from about 20 to about 60 parts by weight diene base polymer (i)(b) based on 100 parts of total weight rubber (phr).

In some aspects, the composition of this disclosure may contain about 20% to about 50%, about 25% to about 50%, about 30% to about 50%, about 35% to about 50%, about 40% to about 50%, about 45% to about 50%, about 20% to about 45%, about 25% to about 45%, about 30% to about 45%, about 35% to about 45%, about 40% to about 45%, about 20% to about 40%, about 25% to about 40%, about 30% to about 40%, about 35% to about 40%, about 20% to about 35%, about 25% to about 35%, about 30% to about 35%, about 20% to about 30%, or about 25% to about 30% of by weight of at least one diene based polymer.

### Precipitated Silica Component (ii)

In one aspect, precipitated silica (ii) is used as the silane-reactive filler. The preferred silicas may be characterized by having a BET surface area, as measured using nitrogen gas, preferably in the range of from about 40 to about 600 m²/g and more usually in a range of from about 50 to about 300 m²/g. The preferred silicas may also be characterized by having a dibutylphthalate (DBP) absorption value in a range of from about 100 to about 350 and more usually from about 150 to about 300. Furthermore, silica filler, as well as the aforesaid alumina and aluminosilicate fillers, may be characterized by having a Cetyl trimethylammonium bromide (CTAB) surface area in a range of about 100 to about 240. The CTAB surface area is the external surface area as measured with cetyl trimethylammonium bromide at a pH of 9 employing the method of ASTM D 3849.

Mercury porosity surface area is the specific surface area as determined by the mercury porosimetry method. According to this method, mercury is allowed to penetrate into the pores of a measured sample of particulate filler after a thermal treatment to remove volatiles therefrom. Typical set-up conditions include a 100 mg sample, removing volatiles over a two hour period at 105° C. and ambient atmospheric pressure, and a pressure ranging from ambient to 2000 bars. The mercury porosimetry method may be performed in accordance with that described in Winslow, Shapiro in ASTM bulletin, page 39 (1959) or according to DIN 66133. For such a method, a CARLO-ERBA Porosimeter 2000 may be used. The average mercury porosity specific surface area for a typical silica filler can range from about 100 to about 300 m²/g.

A suitable pore size distribution for the silica, alumina and aluminosilicate fillers according to the foregoing mercury porosity determination method can be: 5 percent or less of its pores have a diameter of less than 10 nm; from about 60 percent to about 90 percent of its pores have a diameter of about 10 to about 100 nm; from about 10 percent to about 30 percent of its pores have a diameter of from about 100 to about 1,000 nm; and from about 5 percent to about 20 percent of its pores have a diameter of greater than 1,000 nm.

The silica might be expected to have an average ultimate particle size, for example, in the range of from about 0.01 to about 0.05 μm as determined by electron microscopy although the silica particles may be even smaller, and even larger, in size. Various commercially available silicas are useful, such as those from PPG Industries under the HI-SIL trademark with designations HI-SIL 190, 210, 243, etc.; silicas available from Solvay (formerly known as Rhodia), with, for example, the designation ZEOSIL 1165MP, Zeosil 195HR, and Zeosil Premium 200MP; silicas available from Evonik Industries with, for example, designations VN2 and VN3, and Ultrasil 7000GR, etc.; and, silicas commercially available from Huber having, for example, the designation HUBERSIL 8745.

In one aspect, where it is desired for the rubber composition to contain both precipitated silica (ii), and other fillers the non-limiting representative examples of titanium dioxide, alumina and aluminosilicates, siliceous materials such as clays and talc, and their mixtures. Inert, i.e., silane-nonreactive, filler(s), such as carbon black, acetylene black, calcium carbonate, and barium sulfate may be employed along with silane-reactive particulate filler(s) (ii). A combination of silica and carbon black is particularly advantageous for use in rubber products such as tire tread. Alumina can be used either alone or in combination with silica. The term “alumina” herein refers to aluminum oxide, or Al₂O₃. The fillers may be in hydrated or anhydrous form. Use of alumina in rubber compositions is described, for example, in U.S. Pat. No. 5,116,886 and in EPO 0 631,982, which are each incorporated by reference in their entireties herein.

In another aspect, precipitated silica (ii) and carbon black as a filler/reinforcing pigment, it is often preferable that the weight ratio of the precipitated silica to carbon black be at least about 3/1, preferably at least about 10/1 and up to about 30/1. The filler can be comprised of from about 15 to about 95 weight percent precipitated silica and correspondingly from about 5 to about 85 weight percent carbon black wherein the carbon black has a CTAB value in a range of from about 80 to about 150. Alternatively, the filler can be comprised of from about 60 to about 95 weight percent of said precipitated silica and, correspondingly, from about 40 to about 5 weight percent carbon black. The precipitated silica and carbon black filler can be preblended or blended together in the manufacture of the vulcanized rubber.

The precipitated silica (ii) is used in the amount of from about 5 to about 140 parts by weight precipitated silica per 100 parts by weight rubber (phr). In another aspect, the precipitated silica (ii) can specifically be used in the amounts of about 40 to about 110 phr, more specially used in the amounts of from about 60 to about 80 phr. If carbon black is used, the amounts may vary from about 0.5 to about 50 parts by weight carbon black per 100 parts by weight rubber, more specifically from about 1 parts to about 10 phr, and even more specifically, about 2 to about 5 phr. The carbon black is used to impart a black color to the rubber composition, as an ultraviolet (UV) stabilizer and to discharge static electricity that may form from using the articles, such as tires.

Other fillers, such as titanium dioxide, clays, aluminates, siliceous fillers such as alumina silicates, particulate iron oxide and so on, can be used at various levels, including for example, about 1 to about 50 part by weight filler per 100 parts by weight rubber, more specifically from about 5 to about 25 phr.

In some aspects, the composition of this disclosure may contain about 20% to about 50%, about 25% to about 50%, about 30% to about 50%, about 35% to about 50%, about 40% to about 50%, about 45% to about 50%, about 20% to about 45%, about 25% to about 45%, about 30% to about 45%, about 35% to about 45%, about 40% to about 45%, about 20% to about 40%, about 25% to about 40%, about 30% to about 40%, about 35% to about 40%, about 20% to about 35%, about 25% to about 35%, about 30% to about 35%, about 20% to about 30%, or about 25% to about 30% of by weight of precipitated silica.

Coupling Agent Package (iii)

The at least one coupling agent package comprises a mercapto-functional alkylalkoxysilane and a blocked mercapto-functional alkylalkoxysilane.

The coupling agent package (iii) comprises a mercaptosilane (iii)(a) and a blocked mercaptosilane (iii)(b).

In one aspect, the mercaptosilane (iii)(a) has the general formula (X):

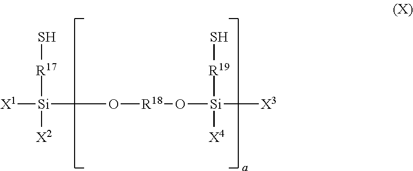

wherein

R¹⁷ is independently a linear alkylene group of from 1 to 6 carbon atoms or a branched alkylene group of from 3 to 6 carbon atoms;

each occurrence of R¹⁸ is an linear alkylene group of from 2 to 8 carbon atoms or a branched alkylene group of from 3 to 8 carbon atoms;

each occurrence of R¹⁹ is independently a linear alkylene group of from 1 to 6 carbon atoms or a branched alkylene group of from 3 to 6 carbon atoms;

X¹ is a —OR²⁰ group, where R²⁰ is an alkyl group of from 1 to 4 carbon atoms, a —OR²¹OH group, where R²¹ is a liner alkylene group of from 2 to 8 carbon atoms or a branched alkylene group of from 3 to 8 carbon atom, or X¹ is a —OR²²(OR²³)_{c}OR²⁴, where R²² is a straight chain alkylene group of from 2 to 6 carbon atoms or a branched chain alkylene group of from 3 to 6 carbon atoms, preferable 3 carbon atoms, each R²³ is independently an alkylene group of from 2 to 4 carbon atoms and R²⁴ is hydrogen, a straight chain alkyl group of from 1 to 16 carbon atoms or a branched chain alkyl group of from 3 to 16 carbon atoms and c is an integer from 1 to 20;

X² and X³ are independently X¹ or methyl;

each occurrence of X⁴ is independently X¹ or methyl; and

a is an integer from 0 to 8, with the provisos that
(i) when X¹ and X² are —OR²⁰, then the two —OR²⁰ may be bonded together through a covalent bond to form a —OR²⁰—R²⁰O— group bonded to the same silicon atom which forms a ring structure containing 2 to 8 carbon atoms, two oxygen atoms and a silicon atom; and
(ii) when a is 1 to 8 and X³ and X⁴ are —OR²⁰, then the two —OR²⁰ groups may be bonded together through a covalent bond to form a —OR²⁰—R²⁰O— group, which is bonded to the same silicon atom to form a ring structure containing 2 to 8 carbon atoms, two oxygen atoms and a silicon atom.

In another aspect, the mercaptosilane (iii)(a) has the structure of formula (I), wherein R¹⁷ is a linear alkylene group of from 1 to 6 carbon atoms or a branched alkylene group of from 3 to 6 carbon atoms, X¹ is a —OR²⁰ group, where R²⁰ is an alkyl group of from 1 to 4 carbon atoms, X² and X³ are independently X¹ or methyl, and the a is 0.

In still another aspect, the mercaptosilane has the structure of formula (I), wherein R¹⁷ is independently a linear alkylene group of from 1 to 6 carbon atoms or a branched alkylene group of from 3 to 6 carbon atoms, each occurrence of R¹⁸ is an linear alkylene group of from 2 to 8 carbon atoms or a branched alkylene group of from 3 to 8 carbon atoms, each occurrence of R¹⁹ is independently a linear alkylene group of from 1 to 6 carbon atoms or a branched alkylene group of from 3 to 6 carbon atoms, X¹ and X² are a —OR²⁰, where R²⁰ is an alkyl group of from 1 to 4 carbon atoms and the two —OR²⁰ groups of X¹ and X² are bonded together through a covalent bond to form a —OR²⁰—R²⁰O— group bonded to the same silicon atom to form a ring structure containing 2 to 8 carbon atoms, two oxygen atoms and a silicon atom group, or each X¹ and X² are a —OR²¹OH group, where R²¹ is a liner alkylene group of from 2 to 8 carbon atoms or a branched alkylene group of from 3 to 8 carbon atom, X³ and X⁴ are independently —OR²⁰ group, where R²⁰ is an alkyl group of from 1 to 4 carbon atoms, a —OR²¹OH group, where R²¹ is a liner alkylene group of from 2 to 8 carbon atoms or a branched alkylene group of from 3 to 8 carbon atom, with the proviso that when X³ and X⁴ are —OR²⁰, then the two —OR²⁰ groups may be bonded together through a covalent bond to form a —OR²⁰—R²⁰O— group bonded to the same silicon atom to form a ring structure containing 2 to 8 carbon atoms, two oxygen atoms and a silicon atom, a is 1 to 8, preferably 1 to 3.

Representative and non-limiting examples of the mercaptosilanes (iii)(a) include 3-mercapto-1-propyltriethoxysilane, 2-mercapto-1-ethyltriethoxysilane, mercaptomethyltriethoxysilane, 6-mercapto-1-hexyltriethoxysilane, 4-mercapto-1-butyltriethoxysilane, 1-mercapto-1-ethyltriethoxysilane, 3-mercapto-1-propylmethyldiethoxysilane, 3-mercapto-1-propyldimethylethoxysilane, 3-mercapto-1-propyltrimethoxysilane, 2-mercapto-1-ethyltrimethoxysilane, mercaptomethyltrimethoxysilane, 6-mercapto-1-hexyltrimethoxysilane, 4-mercapto-1-butyltrimethoxysilane, 1-mercapto-1 ethyltrimethoxysilane, 3-mercapto-1-propylmethyldimethoxysilane, 3-mercapto-1-propyldimethylmethoxysilane, 3-mercapto-1-propyltripropoxysilane, 3-mercapto-1-propyltriisopropoxysilane, 3-mercapto-1-propyltributoxysilane, 4-(3,6,9,12,15-penta-oxaoctacosyloxy)-4-ethoxy-5,8,11,14,17,20-hexaoxa-4-silatritriacontane-1-thiol, 3-(2-{3-[2-(3-mercapto-propyl)-5-methyl-[1,3,2]dioxasilinan-2-yloxy]-2-methyl-propoxy}-5-methyl-[1,3,2]dioxasilinan-2-yl)-propane-1-thiol; 3-(2-{3-[2-(3-mercapto-propy)-4,4,6-trimethyl-[1,3,2]dioxasilinan-2-yloxy]-2-methyl-propoxy}-4,4,6-trimethyl-[1,3,2]dioxasilinan-2-yl)-propane-thiol; 3-(2-{3-[2-(3-mercapto-propyl)-4,4,6-trimethyl-[1,3,2]dioxasilinan-2-yloxy]-1,1-dimethyl-butoxy}-4,4,6-trimethyl-[1,3,2]dioxasilinan-2-yl)-propane-1-thiol; 3-({3-[2-mercapto-propyl)-5-methyl-[1,3,2]dioxasilinan-yloxy]-2-methyl-propoxy}-bis-[3-hydroxy-2-methyl-propoxy]-silanyl)-propane-1-thiol; 3-[{3-[{3-bis-(3-hydroxy-2-methyl-propyl)-(3-mercapto-propyl)-silanyloxy]-1-methyl-propoxy}-(3-hydroxy-2-methyl-propoxy)-(3-mercapto-propyl)-silanyloxy]-2-methyl-propan-1-ol; 3-[[3-((3-hydroxy-3-methyl-propoxy)-3-mercapto-propyl)-{3-[2-(3-mercapto-propyl)-5-methyl-[1,3,2]dioxasilinan-2-yloxy]-1-methyl-propoxy}-silanyloxy)-methyl-propoxy-(3-hydroxy-2-methyl-propoxy)-3-mercapto-propyl)-silanyl]-2-methylpropan-1-ol; 3-(2-{3-[2-(3-mercapato-butyl)-[1,3,2]dioxasilinan-2-yloxy]-propoxy}-[1,3,2]dioxasilinan-2-yl)-butane-1-thiol; 3-({3-[2-mercapto-methyl)-5-methyl-[1,3,2]dioxasilinan-2-yloxy]-2-methyl-propoxy}-diethoxy]-silanyl)-methane-1-thiol; 3-[{3-[{3-bis-(3-hydroxy-2,2-dimethyl-propyl)-(3-mercapto-propyl)-silanyloxy]-2,2-dimethyl-propoxy}-(3-hydroxy-2,2-dimethyl-propoxy)-(3-mercapto-propyl)-silanyloxy]-2,2-dimethyl-propan-1-ol; 3-[{3-[(methyl)-(3-hydroxy-2-methyl-propoxy)-(3-mercapto-propyl)-silanyloxy]-2-methyl-propoxy}-methyl)-(3-mercapto-propyl)-silanyloxy]-2-methyl-propan-1-ol, and combinations thereof.

In another aspect, the blocked mercaptosilane (iii)(b) have the general formula (XI):

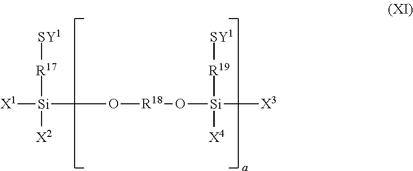

wherein

R¹⁷ is independently a linear alkylene group of from 1 to 6 carbon atoms or a branched alkylene group of from 3 to 6 carbon atoms;

each occurrence of R¹⁸ is an linear alkylene group of from 2 to 8 carbon atoms or a branched alkylene group of from 3 to 8 carbon atoms;

each occurrence of R¹⁹ is independently a linear alkylene group of from 1 to 6 carbon atoms or a branched alkylene group of from 3 to 6 carbon atoms;

X¹ is a —OR²⁰ group, where R²⁰ is an alkyl group of from 1 to 4 carbon atoms, a —OR²¹OH group, where R²¹ is a liner alkylene group of from 2 to 8 carbon atoms or a branched alkylene group of from 3 to 8 carbon atom, or X¹ is a —OR²²(OR²³)_{c}OR²²⁴, where

R²² is a straight chain alkylene group of from 2 to 6 carbon atoms or a branched chain alkylene group of from 3 to 6 carbon atoms, preferable 3 carbon atoms, each R²³ is independently an alkylene group of from 2 to 4 carbon atoms and R²⁴ is a straight chain alkyl group of from 1 to 16 carbon atoms or a branched chain alkyl group of from 3 to 16 carbon atoms and c is an integer from 1 to 20;

X² and X³ are independently X¹ or methyl;

each occurrence of X⁴ is independently X¹ or methyl;

each occurrence of Y¹ is —C(═O)R²⁵ or —C(═S)OR²⁵, wherein each R²⁵ is independently a straight chain alkylene group of from 1 to 16 carbon atoms, more specifically from 5 to 11 carbon atoms and even more specifically from 6 to 9 carbon atom, or a branched chain alkylene group of from 3 to 16 carbon atoms, more specifically from 5 to 11 carbon atoms and even more specifically 6 to 9 carbon atoms; and

a is an integer from 0 to 8, with the provisos that
(i) when X¹ and X² are —OR²⁰, then the two —OR²⁰ may be bonded together through a covalent bond to form a —OR²⁰—R²⁰O— group bonded to the same silicon atom which forms a ring structure containing 2 to 8 carbon atoms, two oxygen atoms and a silicon atom; and
(ii) when a is 1 to 8 and X³ and X⁴ are —OR²⁰, then the two —OR²⁰ groups may be bonded together through a covalent bond to form a —OR²⁰—R²⁰O— group, which is bonded to the same silicon atom to form a ring structure containing 2 to 8 carbon atoms, two oxygen atoms and a silicon atom.

In another aspect, the blocked mercaptosilane (iii)(b) has the structure of formula (I), wherein R¹⁷ is a linear alkylene group of from 1 to 6 carbon atoms or a branched alkylene group of from 3 to 6 carbon atoms, Y¹ is —C(═O)R²⁵ or —C(═S)OR²⁵, wherein each R²⁵ is independently a straight chain alkylene group of from 1 to 16 carbon atoms, more specifically from 5 to 11 carbon atoms and even more specifically from 6 to 9 carbon atom, or a branched chain alkylene group of from 3 to 16 carbon atoms, more specifically from 5 to 11 carbon atoms and even more specifically 6 to 9 carbon atoms, X¹ is a —OR²⁰ group, where R²⁰ is an alkyl group of from 1 to 4 carbon atoms, X² and X³ are independently X¹ or methyl, and a is 0.

In still another aspect, the blocked mercaptosilane (iii)(b) has the structure of formula (I), wherein R¹⁷ is independently a linear alkylene group of from 1 to 6 carbon atoms or a branched alkylene group of from 3 to 6 carbon atoms, each occurrence of R¹⁸ is an linear alkylene group of from 2 to 8 carbon atoms or a branched alkylene group of from 3 to 8 carbon atoms, each occurrence of R¹¹9 is independently a linear alkylene group of from 1 to 6 carbon atoms or a branched alkylene group of from 3 to 6 carbon atoms, Y¹ is —C(═O)R²⁵ or —C(═S)OR²⁵, wherein each R²⁵ is independently a straight chain alkylene group of from 1 to 16 carbon atoms, more specifically from 5 to 11 carbon atoms and even more specifically from 6 to 9 carbon atom, or a branched chain alkylene group of from 3 to 16 carbon atoms, more specifically from 5 to 11 carbon atoms and even more specifically 6 to 9 carbon atoms; X¹ and X² are a —OR²⁰, where R²⁰ is an alkyl group of from 1 to 4 carbon atoms and the two —OR²⁰ groups of X¹ and X² are bonded together through a covalent bond to form a —OR²⁰—R²⁰O— group bonded to the same silicon atom to form a ring structure containing 2 to 8 carbon atoms, two oxygen atoms and a silicon atom group, or each X¹ and X² are a —OR²¹0H group, where R²¹ is a liner alkylene group of from 2 to 8 carbon atoms or a branched alkylene group of from 3 to 8 carbon atom, X³ and X⁴ are independently —OR²⁰ group, where R²⁰ is an alkyl group of from 1 to 4 carbon atoms, a —OR²¹OH group, where R²¹ is a liner alkylene group of from 2 to 8 carbon atoms or a branched alkylene group of from 3 to 8 carbon atom, with the proviso that when X³ and X⁴ are —OR²⁰, then the two —OR²⁰ groups may be bonded together through a covalent bond to form a —OR²⁰-20⁶O— group bonded to the same silicon atom to form a ring structure containing 2 to 8 carbon atoms, two oxygen atoms and a silicon atom, a is 1 to 8, preferably 1 to 3.

Representative and non-limiting examples of the blocked mercaptosilane (iii)(b)include triethoxysilylmethyl thioformate, 2-triethoxysilylethyl thioacetate, 3-triethoxysilylpropyl thiopropanoate, 3-triethoxysilylpropyl thiohexanoate, 3-triethoxysilylpropyl thio-(2-ethyl)-hexanoate, 3-triethoxysilylpropyl thiooctanoate, 3-diethoxymethylsilylpropyl thiooctanoate, 3-ethoxydimethylsilylpropyl thiooctanoate, 3-triethoxysilylpropyl thiododecanoate, 3-triethoxysilylpropyl thiooctadecanoate, 3-trimethoxysilylpropyl thiooctanoate, 3-triacetoxysilylpropyl thioacetate, 3-dipropoxymethylsilylpropyl thiopropanoate, 4-oxa-hexyloxydimethylsilylpropyl thiooctanoate, 3-(2-{3-[2-(4-thia-5-oxo-dodecyl)-5-methyl-[1,3,2]dioxasilinan-2-yloxy]-2-methyl-propoxy}-5-methyl-[1,3,2]dioxasilinan-2-yl)-4-thia-5-oxo-dodecane; 3-(2-{3-[2-(4-thia-5-oxo-dodecyl)-4,4,6-trimethyl-[1,3,2]dioxasilinan-2-yloxy]-2-methyl-propoxy}-4,4,6-trimethyl-[1,3,2]dioxasilinan-2-yl)-4-thia-5-oxo-dodecane; 3-(2-{3-[2-(4-thia-5-oxo-dodecyl)-4,4,6-trimethyl-[1,3,2]dioxasilinan-2-yloxy]-1,1-dimethyl-butoxy}-4,4,6-trimethyl-[1,3,2]dioxasilinan-2-yl)-4-thia-5-oxo-dodecane; 3-({3-[2-thia-3-oxo-decyl)-5-methyl-[1,3,2]dioxasilinan-yloxy]-2-methyl-propoxy}-bis-[3-hydroxy-2-methyl-propoxy]-silanyl)-2-thia-3-oxo-decane; 3-[{3-[{3-bis-(3-hydroxy-2-methyl-propyl)-(4-thia-5-oxo-dodecyl)-silanyloxy]-1-methyl-propoxy}-(3-hydroxy-2-methyl-propoxy)-(4-thia-5-oxo-dodecyl)-silanyloxy]-2-methyl-propan-1-ol; 3-[[3-((3-hydroxy-3-methyl-propoxy)-4-thia-5-oxo-dodecyl)-{3-[2-(4-thia-5-oxo-dodecyl)-5-methyl-[1,3,2]dioxasilinan-2-yloxy]-1-methyl-propoxy}-silanyloxy)-2-methyl-propoxy-(3-hydroxy-2-methyl-propoxy)-4-thia-5-oxo-dodecyl)-silanyl]-2-methylpropan-1-ol; 3-(2-{3-[2-(4-thia-5-oxo-6-ethyl-decyl)-[1,3,2]dioxasilinan-2-yloxy]-propoxy}-[1,3,2]dioxasilinan-2-yl)-4-thia-5-oxo-6-ethyl-decane; 3-({3-[2-thia-3-oxo-octyl)-5-methyl-[1,3,2]dioxasilinan-2-yloxy]-2-methyl-propoxy}-diethoxy]-silanyl)-2-thia-3-oxo-octane; 3-[{3-[{3-bis-(3-hydroxy-2,2-dimethyl-propyl)-(4-thia-5-oxo-dodecyl)-silanyloxy]-2,2-dimethyl-propoxy}-(3-hydroxy-2,2-dimethyl-propoxy)-(4-thia-5-oxo-dodecyl)-silanyloxy]-2,2-dimethyl-propan-1-ol; 3-[{3-[(methyl)-(3-hydroxy-2-methyl-propoxy)-(4-thia-5-oxo-dodecyl)-silanyloxy]-2-methyl-propoxy}-methyl)-(4-thia-5-oxo-dodecyl)-silanyloxy]-2-methyl-propan-1-ol, and combinations thereof.

In some aspects, the blocked mercaptosilanes in the composition of this disclosure is a bifunctional silane that has a blocked thiol and alkoxysilane functionalities. In some aspects, the blocked mercaptosilanes is octanoylthio-1-propyltriethoxysilane.

In some aspects, the mercaptosilane in the process of this disclosure is a bifunctional silane that has thiol and alkoxysilane functionalities. In some aspects, the mercaptosilane is mercaptopropyltriethoxysilane. In some aspects, the mercaptosilane is 4-(3,6,9,12,15-penta-oxaoctacosyloxy)-4-ethoxy-5,8,11,14,17,20-hexaoxa-4-silatritriacontane-1-thiol.

In some aspects, the weight ratio of the blocked mercaptosilane to the mercaptosilane in the process of this disclosure is about 75 to about 25. In some aspects, the weight ratio of the blocked mercaptosilane to the mercaptosilane is about 4.8 to about 1.6, about 7 to about 0.35, about 6.25 to about 0.7, about 5.75 to about 1, about 5.2 to about 1.3, about 4.4 to about 1.9, or about 3.6 to about 2.4. In some aspects, the weight ratio of the blocked mercaptosilane to the mercaptosilane is about 3. In some aspects, the weight ratio of the blocked mercaptosilane to the mercaptosilane is about 2.85 to about 3.15.

The blocked mercaptosilanes are coupling agents for vulcanizable organic polymer(s), such as a diene based polymer containing at least one functional group (i)(a) and a diene based polymer that does not contain a functional group (i)(b), and silane-reactive particulate filler(s) such as precipitated silica (ii). The mixture of mercaptosilanes (III)(a) and blocked mercaptosilanes (iii)(b) are unique in that the high efficiency of the mercapto group can be exploited unaccompanied by the detrimental side effects typically associated with the use of mercaptosilanes such as high processing viscosity, less than desirable filler dispersion, and premature curing (scorch). These benefits are realized due to the mercaptan group being initially at concentration which are below the amounts needed to initiate the undesirable affects. The blocked mercaptosilanes (iii)(b) are unavailable for reaction with the rubber component(s) as a result of its blocking group. Generally, only the reaction of the silane —SiX¹X²X³ group with the silane-reactive filler can occur during the initial stage of the compounding process. Thus, substantial coupling of the filler to the polymer is precluded during mixing thereby minimizing undesirable premature curing (scorch) and the associated undesirable increase in viscosity. One can achieve better cured filled rubber properties, such as a balance of processing, rolling resistance and grip as a consequence of preventing, inhibiting or minimizing premature curing.

The blocked mercaptosilane (iii)(b) can react with the silica surface during mixing, but will remain partially or completely blocked during the nonproductive mixing steps, thereby inhibiting the reactions with the diene based polymer. The diene polymer reacts with the thiol group of the blocked mercaptosilane (iii)(b) only after the blocking group has been removed. The removal of the blocking group is achieved when the blocked mercaptosilane reacts with nucleophiles to form the thiol group.

In some aspects, the at least one coupling agent package (iii) is used in an amount of from about 0.5 to about 20 parts by weight coupling agent package per 100 parts by weight rubber, more specifically from about 1 to about 10 parts by weight coupling agent package (iii) per 100 parts by weight rubber, and even more specifically from about 3 to about 8 parts by weight coupling agent package (iii) per 100 parts by weight rubber.

In some aspects, the weight ratio of the blocked mercapto-functional alkylalkoxysilane (iii)(b) to the mercapto-functional alkylalkoxysilane (iii)(a) in the rubber compositions disclosed herein is about 0.25:1 to about 50:1. In some aspects, the weight ratio of the blocked mercapto-functional alkylalkoxysilane (iii)(b) to the mercapto-functional alkylalkoxysilane (iii)(a) in the rubber compositions disclosed herein is about 0.5:1 to about 20:1. In some aspects, the weight ratio of the blocked mercapto-functional alkylalkoxysilane (iii)(b) to the mercapto-functional alkylalkoxysilane (iii)(a) in the rubber compositions disclosed herein is about 1:1 to about 10:1.

In some aspects, the weight ratio of the blocked mercaptosilane to the mercaptosilane in the rubber compositions disclosed herein is about 0.25:1 to about 50:1.

In some aspects, the mercapto-functional alkylalkoxysilane (iii)(a) can be used in the amount ranging from about 0.1 to about 10 parts by weight mercapto-functional alkylalkoxysilane (iii)(a) per 100 parts by weight rubber, more specifically from 0.5 to about 5 parts by weight mercapto-functional alkylalkoxysilane (iii)(a) per 100 parts by weight rubber and even more specifically from 1 to 3 parts by weight mercapto-functional alkylalkoxysilane (iii)(a) per 100 parts by weight rubber. In some aspects, the blocked mercapto-functional alkylalkoxysilane (iii)(b) can be used in the amount ranging from about about 0.1 to about 15 parts by weight blocked mercapto-functional alkylalkoxysilane (iii)(b) per 100 parts by weight rubber, more specifically from about 1 to about 10 parts by weight blocked mercapto-functional alkylalkoxysilane (iii)(b) per 100 parts by weight rubber and even more specifically from 3 to 8 parts by weight blocked mercapto-functional alkylalkoxysilane (iii)(b) per 100 parts by weight rubber.

In some aspects, the composition of this disclosure may contain about 0.01% to about 10%, about 0.05% to about 10%, about 0.1% to about 10%, about 0.5% to about 10%, about 1% to about 10%, about 2% to about 10%, about 5% to about 10%, about 7% to about 10%, about 0.01% to about 7%, about 0.05% to about 7%, about 0.1% to about 7%, about 0.5% to about 7%, about 1% to about 7%, about 2% to about 7%, about 5% to about 7%, about 0.01% to about 5%, about 0.05% to about 5%, about 0.1% to about 5%, about 0.5% to about 5%, about 1% to about 5%, about 2% to about 5%, about 0.01% to about 2%, about 0.05% to about 2%, about 0.1% to about 2%, about 0.5% to about 2%, about 1% to about 2%, about 0.01% to about 1%, about 0.05% to about 1%, about 0.1% to about 1%, about 0.5% to about 1%, about 0.01% to about 0.5%, about 0.05% to about 0.5%, or about 0.1% to about 0.5% by weight of a mercaptosilane.

### Deblocking Agents (iv)

When the reaction of the coupling agent package comprising the mixture of mercaptosilanes (iii)(a) and blocked mercaptosilanes (iii)(b) is desired to couple the precipitated silica (ii) and other silane-reactive filler(s) to the diene based polymer(s) (i)(a) and (i)(b), at least one deblocking agent (iv) will also be present in the rubber composition.

The deblocking agent(s) (iv) may be present in quantities ranging from about 0.05 to about 20 phr, more particularly in the range of about 0.1 to about 5 phr, and most particularly in the range of from about 0.5 to about 3 phr. If alcohol or water is present (as is common) in the mixture, a catalyst (e.g., tertiary amines, Lewis acids, or thiols) may be used to initiate and promote the release of the blocking groups by hydrolysis or alcoholysis thus liberating the corresponding active mercaptosilanes. Alternatively, the deblocking agent (iv) may be a nucleophile containing a hydrogen atom sufficiently labile such that the hydrogen atom will be transferred to the site of the original blocking group to provide the corresponding active mercaptosilane. Thus, with a blocking group acceptor molecule, an exchange of hydrogen from the nucleophile would occur with the blocking groups of blocked mercaptosilanes to form mercaptosilanes and the corresponding derivative of the nucleophile containing the original blocking group. This transfer of the blocking group from the mercaptosilane to the nucleophile can be driven, for example, by the greater thermodynamic stability of the products (mercaptosilane and nucleophile containing the blocking group) relative to the initial reactants (blocked mercaptosilane and nucleophile). For example, if the nucleophile is an amine containing an N—H bond, transfer of the blocking group from the blocked mercaptosilane (ii)(b) would yield the mercaptosilane and an amide corresponding to the acyl group or a thio carbamate corresponding to the xanthate group.

What is important is that for the blocking group initially present on the blocked mercaptosilane (iii)(b) and the deblocking agent (iv) employed, the initially substantially inactive (from the standpoint of coupling to the organic polymer) blocked mercaptosilane (iii)(b) is substantially converted at the desired point in the rubber compounding procedure to the active mercaptosilane. It is noted that partial amounts of the nucleophile may be used (i.e., a stoichiometric deficiency) if one were to deblock only part of the blocked mercaptosilane (iii)(b) to control the degree of vulcanization of a specific formulation.

Water can be a deblocking agent and is typically present on the filler as a hydrate or bound to the filler in the form of a hydroxyl group.

The deblocking agent (iv) can be added in the curative package or, alternatively, at any other stage in the compounding process as a single component. The deblocking agent (iv) can be an individual agent or produced in situ as a by-product of a reaction.

In one aspect, deblocking agent (iv) is of the formula (XII):

R²⁶[A³-H]_{d} (XII)

wherein:

R²⁶ is a monovalent or polyvalent organic radical containing from 1 to 30 carbon atoms or hydrogen,

each occurrence of A³ is independently an oxygen, sulfur or —NR⁷ group, where each occurrence of R²⁷ is independently a monovalent or polyvalent organic radical containing from 1 to 30 carbon atoms or hydrogen; and,

d is an integer of from 1 to 100, preferably from 1 to 3.

More particularly, each occurrence of R²⁶ is a group derived from a hydrocarbon containing from 1 to 30 carbon atoms obtained by removing one or more hydrogen atoms and, optionally, contains at least one heteroatom selected from the group consisting of oxygen, nitrogen, sulfur and phosphorus and each R²⁶ is an alkyl group or aryl group (when d is 1) or alkylene group or arylene group (when d is 2) or a —C(═NH)— group (when d is 2 and A³ is —NR²⁷—, where R²⁷ is phenyl or an alkyl group of 1 to 10 carbon atoms, such as diphenyl guanidine.

Examples of deblocking agents (iv) in accordance with the foregoing formula include water or mono-alcohols or glycols or polyols, any primary or secondary amines or amines containing C═N double bonds such as imines or guanidines with the proviso that said amine contain at least one N—H (nitrogen-hydrogen) bond. Numerous specific examples of such guanidines, amines and imines are well known in the art as components of rubber, e.g., those disclosed in J. Van Alphen, Rubber Chemicals, (Plastics and Rubber Research Institute TNO, Delft, Holland, 1973), which is incorporated by reference herein consistent with the present disclosure. Some examples include N,N′-diphenylguanidine, N,N′,N″-triphenylguanidine, N,N′-di-ortho-tolylguanidine, orthobiguanide, hexamethylenetetramine, cyclohexylethylamine, dibutylamine and 4,4′-diaminodiphenylmethane.

Any general acid catalyst used to transesterify esters, such as Brönsted or Lewis acids, can be used as catalyst.

The blocking group of the blocked mercaptosilane can be removed during the high temperature curing of the rubber after the low temperature addition of the vulcanization chemicals.

In some aspects, the composition of this disclosure may contain about 0.01% to about 10%, about 0.05% to about 10%, about 0.1% to about 10%, about 0.5% to about 10%, about 1% to about 10%, about 2% to about 10%, about 5% to about 10%, about 7% to about 10%, about 0.01% to about 7%, about 0.05% to about 7%, about 0.1% to about 7%, about 0.5% to about 7%, about 1% to about 7%, about 2% to about 7%, about 5% to about 7%, about 0.01% to about 5%, about 0.05% to about 5%, about 0.1% to about 5%, about 0.50 to about 500 about 10% to about 500, about 2% to about 500, about 0.010% to about 2%, about 0.0500 to about 2%, about 0.1% to about 2%, about 0.5% to about 2%, about 1% to about 2%, about 0.01% to about 1%, about 0.05% to about 1%, about 0.1% to about 1%, about 0.5% to about 1%, about 0.01% to about 0.5%, about 0.05% to about 0.5%, or about 0.1% to about 0.5% by weight of a block mercaptosilane.

### Vulcanization Package (v)

Vulcanization of the vulcanizable component(s) present in the rubber composition herein can be conducted in the presence of one or more sulfur-containing vulcanization agents, examples of which include elemental sulfur (free sulfur) or sulfur-donating vulcanization agents, for example, polymeric polysulfides and sulfur olefin adducts. Other useful sulfur donors, include, for example, morpholine derivatives. Representative of such donors are, for example, but not limited to, dimorpholine disulfide, dimorpholine tetrasulfide, benzothiazyl-2,N-dithiomorpholide, thioplasts, and disulfidecaprolactam.

The selected vulcanization agent(s) is/are conventionally added in the Final Mix, or productive, rubber composition mixing step. The vulcanization agents can be added in the productive mixing stage in amounts ranging from about 0.1 to about 6 phr, with a range of from about 0.5 to about 5 phr and in some cases, from about 1.0 to about 3.0 phr, being preferred.

Vulcanization of the vulcanizable component(s) present in the rubber composition herein can also be conducted in the presence of one or more vulcanization accelerators. Vulcanization accelerators are compounds that increase the speed of vulcanization and that enable vulcanization to proceed at lower temperature and with greater efficiency.

Representative and non-limiting examples include benzothiazoles, guanidine derivatives and thiocarbamates. Specific accelerators of the foregoing and other types include, but are not limited to, mercapto benzothiazole, benzothiazole disulfide, diphenylguanidine, zinc dithiocarbamate, alkylphenoldisulfide, zinc butyl xanthate, N-dicyclohexyl-2-benzothiazolesulfenamide, N-cyclohexyl-2-benzothiazolesulfenamide, N-oxydiethylenebenzothiazole-2-sulfenamide, N,N-diphenylthiourea, dithiocarbamylsulfenamide, N,N-diisopropylbenzothiozole-2-sulfenamide, zinc-2-mercaptotoluimidazole, dithiobis(N-methyl piperazine), dithiobis(N-beta-hydroxy ethyl piperazine), and dithiobis(dibenzyl amine).

Accelerators may be used to control the time and/or temperature required for vulcanization and to improve the properties of the vulcanizate. In one aspect, a single accelerator system may be used, i.e., a primary accelerator. Conventionally and preferably, a primary accelerator(s) is/are used in total amounts ranging from about 0.5 to about 4 phr, preferably about 0.8 to about 1.5 phr. Combinations of a primary and a secondary accelerator may be used with the secondary accelerator being used in smaller amounts (e.g., ranging from about 0.05 to about 3 phr) in order to activate and to improve the properties of the vulcanizate. Delayed action accelerators and/or vulcanization retarders may also be used. Suitable types of accelerators include amines, disulfides, guanidines, thioureas, thiazoles, sulfenamides, dithiocarbamates and xanthates. Preferably, the primary accelerator is a sulfenamide. If a second accelerator is used, the secondary accelerator is preferably a guanidine or dithiocarbamate compound.

In certain aspects, vulcanization accelerators are used alone. In certain aspects, two or more of vulcanization accelerators are used in combination. Representative and non-limiting examples of guanidine vulcanization accelerator include 1,3-diphenylguanidine, 1,3-di-ortho-tolylguanidine, 1-ortho-tolylbiguanide, di-ortho-tolylguanidine salts of dicatechol borate, 1,3-di-ortho-cumenylguanidine, 1,3-diortho-biphenylguanidine, and 1,3-di-ortho-cumenyl-2-propionylguanidine. In some aspects, the vulcanization package in the composition of this disclosure comprises sulfur and a sulfenamide primary accelerator. The accelerator can also function as a deblocking agent (iv), as is the case of diphenyl guanidine, provide it has -A³H group.

### Scorch Modifier (vi)

The rubber composition can contain scorch modifier (vi). In certain aspects, the scorch modifier is a thiuram disulfide scorch modifier. In some aspects, the scorch modifier is has the general formula (XIII):

R²⁸₂NC(═S)SSC(═S)NR²⁸₂ (XIII)

wherein R²⁸ is independently a straight chain alkyl group of from 1 to 12 carbon atoms, a branched chain alkyl group of from 3 to 12 carbon atoms, a cycloalkyl group of from 5 to 12 carbon atoms, an aryl group of from 6 to 12 carbon atoms and an aralkyl group of from 7 to 12 carbon atoms.

Representative and non-limiting examples of scorch modifiers include tetramethylthiuram disulfide, tetraethylthiuram disulfide, tetrapropylthiuram disulfide, tetrabutylthiuram disulfide, tetraphenylthiuram disulfide, tetramethylthiuram monosulfide, zinc dibenzyl dithiocarbamate, and tetrabenzylthiuram disulfide.

The scorch modifier (vi) can be used in amounts ranging from about 0.05 to about 10 parts by weight scorch modifier (vi) per 100 parts rubber (phr) and more specifically from about 0.1 to about 5 parts by weight scorch modifier (vi) per 100 parts rubber (phr) and in some cases, from about 0.15 to about 1.0 parts by weight scorch modifier (vi) per 100 parts rubber (phr) being preferred.

In some aspects, the composition of this disclosure may contain about 0.01% to about 10%, about 0.05% to about 10%, about 0.1% to about 10%, about 0.5% to about 10%, about 2% to about 10%, about 5% to about 10%, about 7% to about 10%, about 0.01% to about 7%, about 0.05% to about 7%, about 0.1% to about 7%, about 0.5% to about 7%, about 2% to about 7%, about 5% to about 7%, about 0.01% to about 5%, about 0.05% to about 5%, about 0.1% to about 5%, about 0.5% to about 5%, about 2% to about 5%, about 0.01% to about 2%, about 0.05% to about 2%, about 0.1% to about 2%, about 0.5% to about 2%, about 0.01% to about 0.5%, or about 0.01% to about 0.05% by weight of a scorch modifier.

### Other Components

Typical amounts of tackifier resins, if used, are about 0.1 to about 15 parts by weight tackifier resin per 100 parts rubber (phr) and more specifically from about 0.5 to about 10 parts by weight tackifier resin per 100 parts rubber (phr), usually about 1 to about 5 parts by weight tackifier resin per 100 parts rubber (phr). Such tackifier resins include rosins and their derivates, terpenes and modified terpenes, aliphatic, cycloaliphatic and aromatic resins, hydrogenated hydrocarbon resins, and their mixtures, terpene-phenol resins and novolacs. Typical amounts of processing aids are about 1 to about 50 parts by weight processing aid per 100 parts by weight rubber (phr). Such processing aids include, for example, aromatic, naphthenic and/or paraffinic processing oils. Typical amounts of antioxidants are about 1 to about 5 parts by weight antioxidant per 100 parts by weight rubber (phr). Representative antioxidants may be, for example, diphenyl-p-phenylenediamine and others such as those disclosed in the Vanderbilt Rubber Handbook (1978), pages 344-46, which is incorporated by reference herein consistent with the present disclosure. Typical amounts of antiozonants comprise about 1 to about 5 parts by weight antiozonants per 100 parts by weight rubber (phr). Typical amounts of fatty acids, which, if used, can include stearic acid, are about 0.5 to about 3 parts by weight fatty acid per 100 parts by weight rubber (phr). Typical amounts of zinc oxide are about 2 to about 5 parts by weight zinc oxide per 100 parts by weight rubber (phr). Typical amounts of waxes are about 1 to about 5 parts by weight wax per 100 parts by weight rubber (phr). Often microcrystalline waxes are used. Typical amounts of peptizers are about 0.1 to about 1 parts by weight peptizer per 100 parts by weight rubber (phr). Typical peptizers may, for example, be pentachlorothiophenol and dibenzamidodiphenyl disulfide.

Addition of an alkyl silane to the coupling agent package, typically in a mole ratio of alkyl silane to the total of the blocked mercaptosilanes (iii)(b) is in a range of from 1/50 to ½, promotes an even better control of rubber composition processing and aging.

In another aspect, the present disclosure is directed to a composition comprising:

about 30% to about 40% by weight of at least one diene based polymer containing at least one functional group,

about 30% to about 40% by weight of precipitated silica,

about 0.05% to about 5% by weight of a blocked mercapto-functional alkylalkoxysilane,

about 0.05% to about 5% by weight of a mercapto-functional alkylalkoxysilane, and

about 0.1% to about 10% by weight of a scorch modifier.

In some aspects, the composition further comprises a vulcanizing agent comprising at least one vulcanizing agent comprising sulfur and at least one accelerator. Any vulcanizing agent and vulcanization accelerator may be used, including those commonly used in the tire industry. Examples of the vulcanization accelerator include but are not limited to guanidines, sulfonamides, thiazoles, thiurams, dithiocarbamates, thioureas, and xanthates. In certain aspects, vulcanization accelerators are used alone. In certain aspects, two or more of vulcanization accelerators are used in combination. Examples of guanidine vulcanization accelerator include 1,3-diphenylguanidine, 1,3-di-ortho-tolylguanidine, 1-ortho-tolylbiguanide, di-ortho-tolylguanidine salts of dicatechol borate, 1,3-di-ortho-cumenylguanidine, 1,3-diortho-biphenylguanidine, and 1,3-di-ortho-cumenyl-2-propionylguanidine. In some aspects, the sulfur in the vulcanizing agent is selected from the group consisting of elemental sulfur, sulfur-donating compounds, and combinations thereof. In some aspects, the composition also comprises sulfur and a sulfenamide primary accelerator.

A single Performance Index Value (or Performance Indices, or “PIV”) is a value that represents the benefits of a composition by compiling and averaging several rubber compound properties, representing various important aspects in the tire and rubber industry. The main reason the PIV is important is because of the interdependency of rubber compound properties. That is, many rubber compound properties can only be improved by negatively impacting another rubber compound property. As an example, for bifunctional silanes, the known trade-off is the improvement of rolling resistance properties at the expense of rubber processability. Accordingly, the improved balance of several performance properties for a composition as represented by the Performance Index Value demonstrates the inventive nature of the composition.

Performance Index Value or Performance Indices or PIV are used interchangeably in the entire disclosure.

The properties that make up the Performance Index Value are shown in Table 1.

TABLE 1
Performance Index Value Properties

| Performance | | | |
|---|---|---|---|
| Indicator | Measurement | Equipment | Method |
| Indicator 1: | Mooney Scorch, | Monsanto | ASTM D-1646 |
| Processing | 3 point rise | MV2000 | |
| Indicator 2: | Shore A Hardness | Zwick Shore | ASTM D-2240 |
| Handling | | Hardness | |
| | | Tester | |
| Indicator 3: Grip | Rebound at 0° C. | Zwick 5109 | ASTM D-7121 |
| | | Rebound | |
| | | Resilience | |
| | | Tester | |
| Indicator 4: Grip | DMA TS tan δ, | ARES-M or | ASTM D6049 |
| | maximum | Metravib | 03(2017) |
| | | DMA + 1000 | |
| Indicator 5: | Mooney Viscosity, | Monsanto | ASTM D-1646 |
| Processing | ML(1 + 4) 100° C. | MV2000 | |
| Indicator 6: RR | RPA SS tan δ at | TA RPA Elite | ASTM D-6601 |
| | 60° C., maximum | | |
| Indicator 7: RR | DMA TS tan δ at | ARES-M or | ASTM D6049 |
| | 60° C. | Metravib | 03(2017) |
| | | DMA + 100 | |
| Indicator 8: Wear | DIN Abrasion | DIN Rotary | ASTM D-5963 |
| | (mass loss) | Abrader | |

A performance index, or multiple performance indices, can be used to evaluate a rubber composition. For example, U.S. Pat. No. 10,494,510 discloses such values to evaluate a rubber composition with multiple performance indices including Rolling Resistance and Grip Performance.

In some aspects, the rubber compositions may have a Mooney viscosity of from about 40 MU to about 150 MU as measured using the ASTM D-1646 method. In a further aspect, the rubber compositions may have a Mooney viscosity of from about 120 MU to about 140 MU. In another aspect, the rubber compositions may have a Mooney viscosity of from about 40 MU to about 100 MU. In some aspects, the rubber compositions may have a Mooney visocity of about 40, about 45, about 50, about 55, about 60, about 65, about 70, about 75, about 80, about 85, about 90, about 95, about 100, about 105, about 110, about 115, about 120, about 125, about 130, about 135, about 140, about 145, or about 150 MU.

In some aspects, the rubber compositions may have a Mooney scorch, 3 pt rise, of from about 2 minutes to about 40 minutes as measured using the ASTM D-1646 method. In a further aspect, the rubber compositions may have a Mooney scorch, 3 pt rise, of from about 30 minutes to about 40 minutes. In another aspect, the rubber compositions may have a Mooney scorch, 3 pt rise, of from about 20 minutes to about 30 minutes. In some aspects, the rubber compositions may have a Mooney scorch, 3 pt rise, of about 2, about 5, about 10, about 15, about 20, about 25, about 30, about 35, or about 40.

In some aspects, the rubber composition may have a tensile strength of from about 5 MPa to about 25 MPa as measured by the ASTM D-412 method. In a further aspect, the rubber composition may have a tensile strength of from about 15 MPA to about 20 MPa. In another aspect, the rubber composition may have a tensile strength of from about 10 MPa to about 15 MPa. In some aspects, the rubber composition may have a tensile strength of about 5, about 10, about 15, about 20, or about 25 MPa.

In some aspects, the rubber composition may have a Shore A hardness of from about 50 Shore A to about 80 Shore A as measured by using the ASTM D-2240 method. In a further aspect, the rubber composition may have a Shore A hardness of from about 55 Shore A to about 65 Shore A. In another aspect, the rubber composition may have a Shore A hardness of from about 65 Shore A to about 75 Shore A. In some aspects, the rubber composition may have a Shore A hardness of about 50, about 55, about 60, about 65, about 70, about 75, or about 80 Shore A.

In some aspects, the rubber composition may have a Rebound at 0° C. of from about 5 to about 20 as measured by using the ASTM D-7121. In a further aspect, the rubber composition may have a Rebound at 0° C. of from about 5 to about 10. In another aspect, the rubber composition may have a Rebound at 0° C. of from about 10 to about 15. In some aspects, the rubber composition may have a Rebound at 0° C. of about 5, about 10, about 15, or about 20.

In some aspects, the rubber composition may have a DMA TS tan δ maximum of from about 0.50 to about 1.00 as measured by using the ASTM D6049 03 (2017). In a further aspect, the rubber composition may have a DMA TS tan δ maximum of from about 0.50 to about 0.75. In another aspect, the rubber composition may have a DMA TS tan δ maximum of from about 0.75 to about 1.00. In some aspects, the rubber composition may have a DMA TS tan δ maximum of about 0.50, about 0.55, about 0.60, about 0.65, about 0.70, about 0.75, about 0.80, about 0.85, about 0.90, about 0.95, or about 1.00.

In some aspects, the rubber composition may have a RPA SS tan δ maximum at 60° C. of from about 0.05 to about 0.20 as measured by using the ASTM D-6601. In a further aspect, the rubber composition may have a RPA SS tan δ maximum at 60° C. of from about 0.05 to about 0.10. In another aspect, the rubber composition may have a RPA SS tan δ maximum at 60° C. of from about 0.10 to about 0.20. In some aspects, the rubber composition may have a RPA SS tan δ maximum at 60° C. of about 0.05, about 0.06, about 0.07, about 0.08, about 0.09, about 0.10, about 0.11, about 0.12, about 0.13, about 0.14, about 0.15, about 0.16, about 0.17, about 0.18, about 0.19, or about 0.20.

In some aspects, the rubber composition may have a DMA TS tan δ at 60° C. of from about 0.05 to about 0.20 as measured by using the ASTM D6049 03 (2017). In a further aspect, the rubber composition may have a DMA TS tan δ at 60° C. of from about 0.05 to about 0.10. In another aspect, the rubber composition may have a DMA TS tan δ at 60° C. of from about 0.10 to about 0.20. In some aspects, the rubber composition may have a DMA TS tan δ at 60° C. of about 0.05, about 0.06, about 0.07, about 0.08, about 0.09, about 0.10, about 0.11, about 0.12, about 0.13, about 0.14, about 0.15, about 0.16, about 0.17, about 0.18, about 0.19, or about 0.20.

In some aspects, the rubber composition may have a DIN abrasion of from about 70 mm³ to about 130 mm³ as measured by using the ASTM D-5963. In a further aspect, the rubber composition may have a DIN abrasion of from about 80 mm³ to about 100 mm³. In another aspect, the rubber composition may have a DIN abrasion of from about 100 mm³ to about 120 mm³. In some aspects, the rubber composition may have a DIN abrasion of about 70 mm³, about 75 mm³, about 80 mm³, about 85 mm³, about 90 mm³, about 95 mm³, about 100 mm³, about 105 mm³, about 110 mm³, about 115 mm³, about 120 mm³, about 125 mm³, or about 130 mm³.

### Process for Preparing Rubber Composition

In some aspects, the disclosure provides a rubber composition containing a composition comprising at least one diene based polymer (i), silica (ii), a coupling agent package comprising a mercaptosilane (iii)(a) and a blocked mercaptosilane (iii)(b), at least one deblocking agent (iv) and a vulcanization package (v) comprising an accelerator and sulfur and a scorch modifier (vi). The rubber composition may be prepared by known methods, such as for example by kneading the components using a rubber kneading machine such as an open roll mill or a Banbury mixer, and vulcanizing the mixture. The rubber composition of the disclosure may be used for various tire components and especially suitable for treads and sidewalls, for example.

Tires formed from the rubber composition can be produced using the rubber composition by usual methods. Specifically, the unvulcanized rubber composition containing various additives as needed is extruded into the shape of a tire component, e.g. a tread, and then assembled with other tire components in a conventional manner on a tire building machine to build an unvulcanized tire. The unvulcanized tire is heat pressed in a vulcanizer to produce a tire. In some aspects, pneumatic or non-pneumatic tires can be produced from the rubber composition. Such pneumatic tires can be used, for example, for passenger vehicles, trucks and buses, or two-wheeled vehicles, or as high performance tires. As used herein, high performance tires refer to tires that are excellent particularly in grip performance, including racing tires for racing vehicles. They are excellent in performance on ice and thus suitable as studless winter tires.

A process of this disclosure prepares a composition comprising adding silica (ii), a mercaptosilane (iii)(a), and a blocked mercaptosilane (iii)(b) to at least one diene based polymer (i) where the diene based polymer (i) comprises at least one diene based polymer containing at least one functional group (i)(a) and/or at least one diene based polymer which does not contain a functional group (i)(b).

In some aspects, weight ratio of the blocked mercaptosilane to the mercaptosilane is greater than 1. In some aspects, the weight ratio of the blocked mercaptosilane to the mercaptosilane in the composition of this disclosure is about 1, about 2, about 3, about 4, about 5, about 6, about 7, about 8, about 9, about 10, about 11, about 12, about 15, about 20, about 25, or about 30. In some aspects, the weight ratio of the blocked mercaptosilane to the mercaptosilane in the composition of this disclosure is about 10 to about 1, about 10 to about 2, about 10 to about 3, about 10 to about 4, about 10 to about 5, about 10 to about 6, about 10 to about 7, about 10 to about 8, about 10 to about 9, about 9 to about 1, about 9 to about 2, about 9 to about 3, about 9 to about 4, about 9 to about 5, about 9 to about 6, about 9 to about 7, about 9 to about 8, about 8 to about 1, about 8 to about 2, about 8 to about 3, about 8 to about 4, about 8 to about 5, about 8 to about 6, about 8 to about 7, about 7 to about 1, about 7 to about 2, about 7 to about 3, about 7 to about 4, about 7 to about 5, about 7 to about 6, about 6 to about 1, about 6 to about 2, about 6 to about 3, about 6 to about 4, about 6 to about 5, about 5 to about 1, about 5 to about 2, about 5 to about 3, about 5 to about 4, about 4 to about 1, about 4 to about 2, about to about 3, about 3 to about 1, about 3 to about 2, or about 2 to about 1.

In some aspects, the at least one coupling agent package (iii) is used in an amount of from about 0.5 to about 20 parts by weight coupling agent package per 100 parts by weight rubber, more specifically from about 1 to about 10 parts by weight coupling agent package (iii) per 100 parts by weight rubber, and even more specifically from about 3 to about 8 parts by weight coupling agent package (iii) per 100 parts by weight rubber.

In some aspects, the weight ratio of the blocked mercapto-functional alkylalkoxysilane (iii)(b) to the mercapto-functional alkylalkoxysilane (iii)(a) in the rubber compositions disclosed herein is about 0.25:1 to about 50:1. In some aspects, the weight ratio of the blocked mercapto-functional alkylalkoxysilane (iii)(b) to the mercapto-functional alkylalkoxysilane (iii)(a) in the rubber compositions disclosed herein is about 0.5:1 to about 20:1. In some aspects, the weight ratio of the blocked mercapto-functional alkylalkoxysilane (iii)(b) to the mercapto-functional alkylalkoxysilane (iii)(a) in the rubber compositions disclosed herein is about 1:1 to about 10:1.

In some aspects, the weight ratio of the blocked mercaptosilane to the mercaptosilane in the rubber compositions disclosed herein is about 0.25:1 to about 50:1.

In some aspects, the mercapto-functional alkylalkoxysilane (iii)(a) can be used in the amount ranging from about 0.1 to about 10 parts by weight mercapto-functional alkylalkoxysilane (iii)(a) per 100 parts by weight rubber, more specifically from about 0.5 to about 5 parts by weight mercapto-functional alkylalkoxysilane (iii)(a) per 100 parts by weight rubber and even more specifically from about 1 to about 3 parts by weight mercapto-functional alkylalkoxysilane (iii)(a) per 100 parts by weight rubber. In some aspects, the blocked mercapto-functional alkylalkoxysilane (iii)(b) can be used in the amount ranging from about 0.1 to about 15 parts by weight blocked mercapto-functional alkylalkoxysilane (iii)(b) per 100 parts by weight rubber, more specifically from about 1 to about 10 parts by weight blocked mercapto-functional alkylalkoxysilane (iii)(b) per 100 parts by weight rubber and even more specifically from 3 to 8 parts by weight blocked mercapto-functional alkylalkoxysilane (iii)(b) per 100 parts by weight rubber.

In some aspects, the process comprises adding a scorch modifier (vi) at the same time as other vulcanization chemicals. In some aspects, the step of adding a scorch modifier (vi) at the same time as other vulcanization chemicals is after the step of adding silica (ii), a mercaptosilane (iii)(a), and a blocked mercaptosilane (iii)(b) to at least one diene based polymer (i)(a) and/or at least one diene base polymer (i)(b). In some aspects, the step of adding a scorch modifier (vi) at the same time as the other vulcanization chemicals is the Final Mix.

In practice, sulfur-vulcanized rubber articles are typically prepared by thermomechanically mixing rubber and various ingredients in a sequentially stepwise manner followed by shaping and curing the compounded rubber to form a vulcanized product. First, for the aforesaid mixing of the rubber and various ingredients, typically exclusive of vulcanizing agents and vulcanization accelerators (collectively “curing agents”), the rubber(s) and various rubber compounding ingredients typically are blended in at least one, and often (in the case of silica-filled low rolling resistance tires) two, preparatory thermomechanical mixing stage(s) in suitable mixers. The deblocking agent and scorch modifier can be added either to the preparatory thermomechanical mixing stages or the final mixing stage. Such preparatory mixing is referred to as nonproductive mixing or nonproductive mixing steps or stages. Such preparatory mixing usually is conducted at temperatures of up to about 1000 to about 200° C. and often up to about 1400 to about 180° C. Subsequent to such preparatory mix stages, in a final mixing stage, sometimes referred to as a productive mixing stage, in which vulcanization agent(s), deblocking agent(s) if not added in the preparatory thermomechanical mixing stages, scorch modifier(s) if not added in the preparatory thermomechanical mixing stages, and possibly one or more additional ingredients are mixed with the rubber composition, typically at a temperature within a range of from about 500 to about 130° C., which is a lower temperature than the temperatures utilized in the preparatory mix stages to prevent or retard premature curing of the curable rubber, sometimes referred to as scorching. The rubber mixture, variously referred to as a rubber compound or rubber composition, is typically allowed to cool, sometimes during or after a process intermediate mill mixing carried out between the aforesaid various mixing steps, for example, to a temperature of about 50° C. or lower. When it is desired to mold and to cure the rubber, the rubber is placed into the appropriate mold at about at least 130° C. and up to about 200° C., causing the vulcanization of the diene based rubber(s) by the mercapto groups on the unblocked mercaptosilanes and any other vulcanizing agent(s), e.g., free sulfur source(s) that may be present in the rubber mixture.

By thermomechanical mixing, it is meant that the rubber compound, or composition of rubber and rubber compounding ingredients, is mixed in a rubber mixer under high shear conditions where it autogenously heats up as a result of the mixing primarily due to shear and associated friction within the rubber mixture in the rubber mixer. Several chemical reactions may occur at various steps in the mixing and curing processes.

The first reaction is a relatively fast reaction and may be considered to take place between the filler and the alkoxysilyl group of mercaptosilane and blocked mercaptosilanes. Such reaction may occur at a relatively low temperature such as, for example, at about 120° C. The second and third reactions may be considered herein to be the deblocking of the mercaptosilane and the subsequent reaction which takes place between the sulfuric part of the mercaptosilane, including the mercaptosilane after deblocking, and the sulfur-vulcanizable rubber(s) at a higher temperature, for example, above about 140° C.

Another sulfur source may be used, for example, in the form of elemental sulfur as Ss. A sulfur donor is considered herein as a sulfur containing compound which liberates free, or elemental, sulfur at a temperature in a range of about 140 to about 190° C. Examples of such sulfur donors may be, but are not limited to, polysulfide vulcanization accelerators and organosilane polysulfides with at least two connecting sulfur atoms in its polysulfide bridge. The amount of free sulfur source addition to the mixture can be controlled or manipulated as a matter of choice relatively independently from the addition of the aforesaid blocked mercaptosilane. Thus, for example, the independent addition of a sulfur source may be manipulated by the amount of addition thereof and by sequence of addition relative to addition of other ingredients to the rubber mixture.

In one aspect, a rubber composition is prepared by the process which comprises:

a) thermomechanically mixing, in at least one preparatory mixing step, to a first elevated temperature, e.g., from about 140° C. to about 200° C., preferably from about 160° C. to about 190° C., and more preferably about 155° C. to about 170° C., for a suitable period, e.g., from 20 minutes and preferably from about 4 to about 15 minutes:

at least one diene based polymer containing at least one functional group (i)(a) and/or at least one diene based polymer which do not contain a functional group (i)(b), e.g., 100 parts by weight thereof,

a precipitated silica (ii), e.g., from about 5 to about 140 phr (parts by weight per hundred parts by weight rubber), preferably about 25 to about 110 phr, or a mixture of precipitated silica and other fillers,

a coupling agent package (iii), which is a mixture of at least one mercaptosilane (iii)(a) and at least one blocked mercaptosilane (iii)(b), e.g., in a total amount of said mixture (coupling agent package (iii)) of from about 1 to about 20 phr;

an optionally, part or all of a deblocking agent (iv) and/or a scorch modifier (vi);

b) blending the mixture resulting from (a), in a final thermomechanical mixing step, at a second elevated temperature which is less than the first elevated temperature, e.g., from about 50° to about 130° C., for a suitable period, e.g., from up to about 30 minutes and preferably from about 1 to about 3 minutes, at least one deblocking agent (iv) if not included in step (a), preferably at from about 0.05 to about 20 phr, at least one scorch modifier (vi) if not included in step (a), and, a vulcanization package at from about 0.1 to about 10 phr; and, optionally,

c) curing said mixture from step (b) at a third elevated temperature, e.g., from about 1300 to about 200° C., for a suitable period, e.g., from about 5 to about 60 minutes. In another aspect, the foregoing process may also comprise the additional steps of preparing an assembly of a tire or vulcanizable rubber with a tread comprised of the rubber composition prepared according to processes described herein and vulcanizing the assembly at a temperature within the range of about 1300 to about 200° C.

In one aspect, a rubber composition is prepared by the process which comprises:

a) thermomechanically mixing, in at least one preparatory mixing step, to a first elevated temperature, e.g., from about 140° C. to about 200° C., preferably from about 160° C. to about 190° C., and more preferably about 155° C. to about 170° C., for a suitable period, e.g., from 20 minutes and preferably from about 4 to about 15 minutes:

at least one diene based polymer containing at least one functional group (i)(a) and at least one diene based polymer which do not contain a functional group (i)(b), e.g., 100 parts by weight thereof,

a precipitated silica (ii), e.g., from about 5 to about 140 phr (parts by weight per hundred parts by weight rubber), preferably about 25 to about 110 phr, or a mixture of precipitated silica and other fillers,

a coupling agent package (iii), which is a mixture of at least one mercaptosilane (iii)(a) and at least one blocked mercaptosilane (iii)(b), e.g., in a total amount of said mixture (coupling agent package (iii)) of from about 1 to about 20 phr;

an optionally, part or all of a deblocking agent (iv) and/or a scorch modifier (vi);

b) blending the mixture resulting from (a), in a final thermomechanical mixing step, at a second elevated temperature which is less than the first elevated temperature, e.g., from about 50° to about 130° C., for a suitable period, e.g., from up to about 30 minutes and preferably from about 1 to about 3 minutes, at least one deblocking agent (iv) if not included in step (a), preferably at from about 0.05 to about 20 phr, at least one scorch modifier (vi) if not included in step (a), and, a vulcanization package at from about 0.1 to about 10 phr; and, optionally,

c) curing said mixture from step (b) at a third elevated temperature, e.g., from about 1300 to about 200° C., for a suitable period, e.g., from about 5 to about 60 minutes. In another aspect, the foregoing process may also comprise the additional steps of preparing an assembly of a tire or vulcanizable rubber with a tread comprised of the rubber composition prepared according to processes described herein and vulcanizing the assembly at a temperature within the range of about 1300 to about 200° C.

In yet another aspect, the rubber composition can be used for the fabrication of a variety of articles. For example, it can be used for various tire compounds such as tread, sidewall, bead and the like. Such tires can be built, shaped, molded and cured by various methods which are known and will be readily apparent to those having skill in such art. Others include hoses, belts, rollers, insulation jacketing, industrial goods, shoe soles, bushings, damping pads, and the like.

The invention may be better understood by reference to the following examples in which the parts and percentages are by weight unless otherwise indicated.

### EXAMPLES

The ingredients for preparing rubber compositions are:

The non-functionalized solution-styrene butadiene rubber is an oil-extended polymer obtainable from Trinseo dba Synthos S.A. called Sprintan™ SLR 4630, having a Mooney viscosity (ML 1+4 (100° C.)) of 55 MU, a bound styrene amount of 25.0%, a vinyl content of 62.0%, TDAE oil amount of 37.5 phr, and a dry polymer glass transition temperature of −19° C.

The carbon black active functionalized solution-styrene butadiene is a dry polymer obtainable from Trinseo dba Synthos S.A. called Sprintan™ SLR 4601, having a Mooney viscosity (ML 1+4 (100° C.)) of 50 MU, a bound styrene amount of 21.0%, a vinyl content of 62.0%, no oil, and a dry polymer glass transition temperature of −25° C.

The silica and carbon black active functionalized solution-styrene butadiene is a dry polymer obtainable from Trinseo dba Synthos S.A. called Sprintan™ SLR 4602, having a Mooney viscosity (ML 1+4 (100° C.)) of 50 MU, a bound styrene amount of 21.0%, a vinyl content of 62.0%, no oil, and a dry polymer glass transition temperature of −25° C.

The butadiene rubber is a neodymium (Nd) catalyzed high-cis polybutadiene obtainable from CHIMEI Corporation under the tradename KIBIPOL® HBR PR-040G, having a Mooney viscosity (ML 1+4 (100° C.)) range of 39-49 MU, cis-butadiene content >97%, and vinyl content <1%.

The precipitated synthetic amorphous silica is a highly dispersible silica (HDS) micropearl obtainable from Solvay Group (formerly known as Rhodia) under the tradename ZEOSIL® 1165MP having a BET nitrogen surface area of 165 m²/g.

The carbon black is a medium reinforcing black filler obtainable from Tokai Carbon CB via Harwick Standard called N330, having a BET nitrogen surface area of 78 m²/g.

Silane 1 is octanethioic acid, S-[3-(triethoxysilyl)propyl] ester, CAS No. 220727-26-4, obtainable from Momentive Performance Materials, Inc. under the tradename Silquest* NXT* silane.

Silane 2 is 3-triethoxysilylpropane-1-thiol, CAS No. 13814-09-6, obtainable from Momentive Performance Materials, Inc. under the tradename Silquest* A-1891 silane.

The process oil is treated distillate aromatic extracted (TDAE) oil, obtainable from H&R Group under the tradename Vivatec 500.

The processing aid is a rubber soluble zinc soap of high-molecular weight fatty acid, obtainable from Struktol Company of America, LLC under the tradename Struktol© A60.

The Antidegradant 1 is N-(1,3-dimethylbutyl)-N′-phenyl-p-phenylenediamine, obtainable from Harwick Standard under the tradename Stangard® 6PPD.

The Antidegradant 2 is a microcrystalline-paraffin blended wax, obtainable from Akrochem under the trade name AKROWAX© 5084.

The Antidegradant 3 is 2,2,4-trimethyl-1,2-dihydroquinoline polymer, obtainable from Harwick Standard under the trade name Stangard© TMQ.

Activator 1 is zinc oxide, obtainable from Harwick Standard under the trade name Zinc Oxide CR-40.

Activator 2 is steric acid, obtainable from Harwick Standard under the trade name Stearic Acid F-2000.

The curative is sulfur, obtainable from Georgia Gulf Sulfur Corp under the trade name Rubber Makers Sulfur.

The accelerator is N-cyclohexyl-2-benzothiazole sulfonamide, obtainable from Harwick Standard under the trade name KEMAI CBS GR.

The tackifying resin is an unsaturated aromatic hydrocarbon resin derived from the polymerizations of unsaturated aromatic olefins and diolefins and diolefin derived from thermal cracking of naphaths, obtainable from Akrochem under the tradename AKROCHEM©P-90 Resin.

The scorch modifier is tetra-benzyl thiuram disulfide, obtainable from Akrochem under the trade name AKROCHEM® Accelerator TBzTD.

The test procedures for evaluating the vulcanized (cured) rubber compositions herein are described in the following ASTM or DIN methods (Table 2):

TABLE 2
ASTM or DIN Methods

| Performance | | | |
|---|---|---|---|
| Indicator | Measurement | Equipment | Method |
| Indicator 1: | Mooney Scorch, | Monsanto | ASTM D-1646 |
| Processing | 3 point rise | MV2000 | |
| Indicator 2: | Shore A Hardness | Zwick Shore | ASTM D-2240 |
| Handling | | Hardness | |
| | | Tester | |
| Indicator 3: Grip | Rebound at 0° C. | Zwick 5109 | ASTM D-7121 |
| | | Rebound | |
| | | Resilience | |
| | | Tester | |
| Indicator 4: Grip | DMA TS tan δ, | ARES-M or | ASTM D6049 |
| | maximum | Metravib | 03(2017) |
| | | DMA + 1000 | |
| Indicator 5: | Mooney Viscosity, | Monsanto | ASTM D-1646 |
| Processing | ML(1 + 4) 100° C. | MV2000 | |
| Indicator 6: RR | RPA SS tan δ at | TA RPA Elite | ASTM D-6601 |
| | 60° C., maximum | | |
| Indicator 7: RR | DMA TS tan δ at | ARES-M or | ASTM D6049 |
| | 60° C. | Metravib | 03(2017) |
| | | DMA + 100 | |
| Indicator 8: Wear | DIN Abrasion | DIN Rotary | ASTM D-5963 |
| | (mass loss) | Abrader | |

Rolling resistance is abbreviated as RR, strain sweep is abbreviated as SS, temperature sweep is abbreviated as TS, rubber processing analyzer is abbreviated as RPA and dynamic mechanical analyzer is abbreviated as DMA.

### Comparative Example 1

### Preparation and Evaluation of a Rubber Composition

TABLE 3
Example 1 Rubber Formulation

| | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|
| Sprintan ™ SLR4630 | 110 | 110 | 110 | 110 | 110 | | | | | | | | | | |
| Sprintan ™ SLR4601 | | | | | | 80 | 80 | 80 | 80 | 80 | | | | | |
| Sprintan ™ SLR4602 | | | | | | | | | | | 80 | 80 | 80 | 80 | 80 |
| KIBIPOL ® HBR PR-040G | 20 | 20 | 20 | 20 | 20 | 20 | 20 | 20 | 20 | 20 | 20 | 20 | 20 | 20 | 20 |
| ZEOSIL ® 1165MP | 95 | 95 | 95 | 95 | 95 | 95 | 95 | 95 | 95 | 95 | 95 | 95 | 95 | 95 | 95 |
| N330 | 5 | 5 | 5 | 5 | 5 | 5 | 5 | 5 | 5 | 5 | 5 | 5 | 5 | 5 | 5 |
| Vivatec 500 | 5 | 5 | 5 | 5 | 5 | 35 | 35 | 35 | 35 | 35 | 35 | 35 | 35 | 35 | 35 |
| Struktol ® A60 | 2 | 2 | 2 | 2 | 2 | 2 | 2 | 2 | 2 | 2 | 2 | 2 | 2 | 2 | 2 |
| Stangard ® 6PPD | 3 | 3 | 3 | 3 | 3 | 3 | 3 | 3 | 3 | 3 | 3 | 3 | 3 | 3 | 3 |
| Stangard ® TMQ | 1 | 1 | 1 | 1 | 1 | 1 | 1 | 1 | 1 | 1 | 1 | 1 | 1 | 1 | 1 |
| ARROWAX ® 5084 | 2 | 2 | 2 | 2 | 2 | 2 | 2 | 2 | 2 | 2 | 2 | 2 | 2 | 2 | 2 |
| NXT* silane | 7.6 | 5.7 | 3.8 | 1.9 | | 7.6 | 5.7 | 3.8 | 1.9 | | 7.6 | 5.7 | 3.8 | 1.9 | |
| Silquest* A-1891 | | 1.2 | 2.5 | 3.7 | 5 | | 1.2 | 2.5 | 3.7 | 5 | | 1.2 | 2.5 | 3.7 | 5 |
| Zinc Oxide CR-40 | 1 | 1 | 1 | 1 | 1 | 1 | 1 | 1 | 1 | 1 | 1 | 1 | 1 | 1 | 1 |
| Stearic Acid F-2000 | 2.5 | 2.5 | 2.5 | 2.5 | 2.5 | 2.5 | 2.5 | 2.5 | 2.5 | 2.5 | 2.5 | 2.5 | 2.5 | 2.5 | 2.5 |
| AKROCHEM ® P-90 Resin | 2 | 2 | 2 | 2 | 2 | 2 | 2 | 2 | 2 | 2 | 2 | 2 | 2 | 2 | 2 |
| MB1 Total (phr) | 257.1 | 275.4 | 257.8 | 258.1 | 258.5 | 262.1 | 262.4 | 262.8 | 263.1 | 263.5 | 267.1 | 267.4 | 267.8 | 268.1 | 268.5 |
| MB2 Total (phr) | 257.1 | 275.4 | 257.8 | 258.1 | 258.5 | 262.1 | 262.4 | 262.8 | 263.1 | 263.5 | 267.1 | 267.4 | 267.8 | 268.1 | 268.5 |
| Zinc Oxide CR-40 | 2 | 2 | 2 | 2 | 2 | 2 | 2 | 2 | 2 | 2 | 2 | 2 | 2 | 2 | 2 |
| Rubber Makers Sulfur | 2.3 | 2.3 | 2.3 | 2.3 | 2.3 | 2.3 | 2.3 | 2.3 | 2.3 | 2.3 | 2.3 | 2.3 | 2.3 | 2.3 | 2.3 |
| CBS | 1.8 | 1.8 | 1.8 | 1.8 | 1.8 | 1.8 | 1.8 | 1.8 | 1.8 | 1.8 | 1.8 | 1.8 | 1.8 | 1.8 | 1.8 |
| TBz TD | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 |
| FM Total (phr) | 263.5 | 263.8 | 264.2 | 264.5 | 264.9 | 268.5 | 268.8 | 269.2 | 269.5 | 269.9 | 273.5 | 273.8 | 274.2 | 274.5 | 274.9 |

TABLE 4
Performance Indicators and Indeces

| Indicator | Performance | Property | Units | 1 | 2 | 3 | 4 | 5 | 6 | 7 | 8 |
|---|---|---|---|---|---|---|---|---|---|---|---|
| 1 | Rubber | Mooney | minutes | 21.5 | 24.4 | 10.4 | 4.5 | 2.2 | 28.8 | 25.4 | 9.7 |
| | Processing | Scorch, 3 | | | | | | | | | |
| | | point rise | | | | | | | | | |
| 2 | Tire | Shore A | Shore A | 71.8 | 70 | 67.6 | 66.6 | 64.9 | 70.6 | 70.1 | 68.6 |
| | Handling | Hardness | | | | | | | | | |
| 3 | Tire Grip | Rebound | N/A | 11.4 | 11 | 10.7 | 10.1 | 9.9 | 13.4 | 12.7 | 13 |
| | | at 0° C. | | | | | | | | | |
| 4 | Tire Grip | DMA TS | N/A | 0.633 | 0.640 | 0.671 | 0.714 | 0.762 | 0.608 | 0.606 | 0.666 |
| | | tan δ | | | | | | | | | |
| | | maximum | | | | | | | | | |
| 5 | Rubber | Mooney | MU | 84.7 | 79.5 | 79.5 | 84.7 | 106.4 | 44.6 | 49.4 | 54.1 |
| | Processing | Viscosity ML | | | | | | | | | |
| | | (1 + 4) | | | | | | | | | |
| 6 | Tire | RPA SS tan | N/A | 0.156 | 0.111 | 0.098 | 0.083 | 0.079 | 0.157 | 0.141 | 0.122 |
| | Rolling | δ maximum | | | | | | | | | |
| | Resistance | at 60° C. | | | | | | | | | |
| 7 | Tire | DMA TS | N/A | 0.130 | 0.127 | 0.119 | 0.109 | 0.104 | 0.162 | 0.146 | 0.129 |
| | Rolling | tan δ | | | | | | | | | |
| | Resistance | at 60 ° C. | | | | | | | | | |
| 8 | Tire Wear | DIN Abrasion | mm\hat{ }3 | 116 | 104 | 93 | 89 | 85 | 118 | 105 | 95 |
| | | (mass loss) | | | | | | | | | |

| Performance Index | | | | 100 | 109 | 105 | 107 | 106 | 100 | 101 | 100 |
|---|---|---|---|---|---|---|---|---|---|---|---|
| | Indicator | Performance | Property | Units | 9 | 10 | 11 | 12 | 13 | 14 | 15 |
| | 1 | Rubber | Mooney | minutes | 3.3 | 2.4 | 30.5 | 27.7 | 14.4 | 4.1 | 2.6 |
| | | Processing | Scorch, 3 | | | | | | | | |
| | | | point rise | | | | | | | | |
| | 2 | Tire | Shore A | Shore A | 67.2 | 64.6 | 65.8 | 64.4 | 62.9 | 62.4 | 62.4 |
| | | Handling | Hardness | | | | | | | | |
| | 3 | Tire Grip | Rebound | N/A | 14.1 | 15 | 13.9 | 13.7 | 14.1 | 13.7 | 13.5 |
| | | | at 0° C. | | | | | | | | |
| | 4 | Tire Grip | DMA TS | N/A | 0.746 | 0.789 | 0.730 | 0.823 | 0.909 | 0.883 | 0.813 |
| | | | tan δ | | | | | | | | |
| | | | maximum | | | | | | | | |
| | 5 | Rubber | Mooney | MU | 65.1 | 130.6 | 59.4 | 61.5 | 64.6 | 72.3 | 96.5 |
| | | Processing | Viscosity ML | | | | | | | | |
| | | | (1 + 4) | | | | | | | | |
| | 6 | Tire | RPA SS tan | N/A | 0.095 | 0.085 | 0.099 | 0.078 | 0.063 | 0.064 | 0.071 |
| | | Rolling | δ maximum | | | | | | | | |
| | | Resistance | at 60° C. | | | | | | | | |
| | 7 | Tire | DMA TS | N/A | 0.116 | 0.110 | 0.126 | 0.108 | 0.095 | 0.094 | 0.103 |
| | | Rolling | tan δ | | | | | | | | |
| | | Resistance | at 60 ° C. | | | | | | | | |
| | 8 | Tire Wear | DIN Abrasion | mm\hat{ }3 | 91 | 85 | 101 | 89 | 80 | 81 | 81 |
| | | | (mass loss) | | | | | | | | |

| | | | | | | | |
|---|---|---|---|---|---|---|---|
| Performance Index | 105 | 106 | 100 | 107 | 110 | 103 | 95 |

Rubber composition is prepared by mixing the ingredients as follows in a BANBURY® (Model BR-1600, ASTM 3182 certified laboratory mixer, Farrell Corp.) mixer with a 103 cu. in. (1690 cc) chamber volume. The mixing of the rubber is performed in three steps.

The mixer is set at a rotor speed of 75 rpm and a temperature of 130° F.+/−10° F. (55° C.) and maintained at this temperature using cooling water. In the first mixing step, to be referred to as Masterbatch 1, the rubber polymers are added to the mixer and ram down mixed for 40 seconds. Half of the silica and Silane 1 and/or Silane 2 are added to the mixer and ram down mixed for 50 seconds, whereas Silane 1 is NXT* silane and Silane 2 is Silquest* A-1891. The rest of the silica and the other ingredients of Masterbatch 1, except for the carbon black and process oil, are added and mixed to a temperature of 257° F. (125° C.). The carbon black and process oil are added to the mixer and mixed to a temperature of 275° F. (135° C.). The mixer is swept to ensure all the materials are added to the mixing chamber. The ingredients are mixed to a temperature of 302° F. (150° C.) at a speed of less than 95 rpm, and held at temperature for 90 seconds. The total mixing time is between 420 and 430 seconds.

The material is discharged from the mixing chamber and milled on a two-roll mill (two cylinder roll mills, Farrell Corp.) set at a temperature of approximately 140° F. (60° C.). The rubber is allowed to wrap around one cylinder and form a rolling bank of rubber at the nip between the two cylinders. A cross-cut of the rubber during milling while wrapped, starting with a 1 inch ribbon, from left to right with 1 inch per revolution is made as the rubber is removed from the mill. The milling steps are repeated five times and then allowed to cool to ambient temperature. The milled rubber is designated as Masterbatch 1, which is a non-productive mixing step.

In the second mixing step, referred to as Masterbatch 2, or a remill step, the rubber composition of Masterbatch 1 is recharged into the mixer. The mixer's speed is 75 rpm, the mixer temperature is 140° F.+/−10° F. (60° C.) and the mixing time is 40 seconds. The temperature is increased to 275° F. (135° C.) and held at temperature for 30 seconds. The mixer is swept. The rubber is then mixed to a temperature of 302° F. (150° C.) at a speed of less than 95 rpm, and held at temperature for 90 seconds. The total mixing time is between 300 to 315 seconds.

The material is discharged from the mixing chamber and milled on a two-roll mill set at a temperature of approximately 140° F. (60° C.). The rubber is allowed to wrap around one cylinder and form a rolling bank of rubber at the nip between the two cylinders. A cross-cut the rubber, starting with a 1 inch ribbon, from left to right with 1 inch per revolution is made as the rubber is removed from the mill. The milling steps are repeated five times and then allowed to cool to ambient temperature. The milled rubber is designated as Masterbatch 2, which is a non-productive mixing step.

In the third mixing step, referred to as Masterbatch 3, or Final Mix (FM), the mixer temperature is set at 100° F.+/−10° F. (38° C.). Masterbatch 2 and the vulcanization chemicals are charged into the mixer along with the curatives and mixed at 50 rpm. The rubber is mixed until a temperature of 200° F. (93° C.) is achieved and then held at temperature for a total mixing time of 170 seconds. The rubber is further mixed at less than 75 rpm until a temperature of 212° F. (100° C.) is reached. The rubber is mixed for a total of between 210 and 215 seconds.

After mixing the Masterbatch 3 is discharged from the mixing chamber and milled on a two-roll mill set at a temperature of approximately 140° F. (60° C.), to form a sheet, and then allowed cool to ambient temperature. The sheet is used to measure the uncured properties, such as Mooney viscosity and Mooney scorch.

The sheet is cured. The curing condition was 160° C. for 20 minutes. The cured sheet is used to measure the cured properties of the rubber composition.

In the rubber composition evaluations, the Performance Index Value is used. The Performance Index Value is calculated by first determining for each indicator a ratio of the measured indicator property value for the rubber composition (PIPᵢ). The ratio for performance indicator properties (PIPᵢ) Processing Indicator 1 (Mooney Scorch, 3 point rise), Handling Indicator 2 (Shore A Hardness), Grip Indicator 3 (Rebound at 0° C.) and Grip Indicator 4 (DMA TS tan δₘₐₓ) are calculated by dividing the values of measured performance indicator (PIPᵢ) value by the measured indicator value for the control rubber composition (PIPᵢₒ). The ratio for the performance indicator properties (PIPᵢ) Processing Indicator 5 (Mooney viscosity, ML(1+4) 100° C.), Rolling Resistance Indicator 6 (RPA SS tan δ at 60° C., max), Rolling Resistance Indicator 7 (DMA TS tan δ at 60° C.), Wear Indicator 8 (DIN Abrasion) are calculated by dividing the values of the measured performance indicator of the control rubber composition, (PIPᵢₒ) by the values of measured performance indicator (PIPᵢ). The equation for calculating the Performance Index is:

$$Performance Index = 12.5 \times ( {{\sum }^{i = 4}}_{= 1} ( {PIP}_{i} / {PIP}_{i o} ) + {\sum }_{i = 5}^{i = 8} ( {PIP}_{i o} / PI {P}_{i} ) i )$$

where

PIPᵢ is the value of the indicator property having the number i for the rubber composition;

PIPᵢₒ is the value of the control indicator property having the number i for the control rubber composition, in which the control rubber composition contained Silane 1; and

i is the number of the indicator property.

The data from the Examples supports the synergistic effect for the combination of Silanes 1 and 2 that have different weight ratios, and the use of functionalized polymer. For example, the Performance Indeces for compounds 11-15 indicate an improvement with the blend of Silane 1 and 2 compared to the individual silanes when compared to the control compounds 1-14, where the SSBRs used in compounds 1-14 are non-functional for silica and the SSBR used in compounds 11-15 is functional for silica. These Performance Index values indicate that the functional polymer rubber compositions with both Silane 1 and 2 provide an improvement in many key parameters, such as wear, rolling resistance, grip and handling, when compared to a rubber composition based on non-functionalized polymers and only Silane 1 or 2. Further, the Δ Tan δ (0° C.-60° C.) values from working Examples demonstrate the benefits of the invention. The blend of Silane 1 and 2 demonstrate an improvement in Δ Tan δ (0° C.-60° C.) values versus rubber composition containing only Silane 1 or Silane 2. Still further benefits are observable for wet traction tan δ at 0° C. (Metravib-Temperature Sweep at 60° C. at 0.5%, 2% dsa). The present compositions demonstrate a statistically significant increase in wet traction property. The present compositions also demonstrate a synergy in that the rubber composition containing only Silane 1 or rubber composition containing only Silane 2 has a worse wet traction indicator (lower values) than the rubber compositions containing both Silane 1 and Silane 2.

### Example 2

### Preparation of 3-(2-ethylhexanoylthio)-1-propyltriethoxysilane

The reactor consisted of a 5-Liter round-bottom reaction flask fitted with a mechanical stirring impeller, addition funnel, thermocouple, nitrogen inlet, and gas outlet. The gas outlet was fed to a scrubber of aqueous sodium hydroxide for trapping hydrogen sulfide evolved by the process. The thermocouple was fitted to an electronic temperature controller. A stripping apparatus was also assembled for removing residual water from the product. This apparatus consisted of a 1-L round-bottom flask fitted with a thermocouple and 5-plate bubble plate (Oldershaw) column. The column was fitted with a short-path distillation head to which was fitted a collection flask for the collection of distillate. Vacuum was supplied to the head via a mechanical vacuum pump. A dry ice cooled cold trap was placed between the distillation head and pump to trap volatiles. The absolute pressure was monitored between the cold trap and vacuum pump by an electronic pressure gauge. The contents of the flask were agitated with a magnetic stir bar and stir motor.

The reaction flask was initially charged with 785 grams of 45% aqueous sodium hydrosulfide (6.30 moles NaSH) and deionized water (676 grams; 37.5 moles). The mixture was gently stirred with a mechanical stirrer, whereupon crystals of tetrabutylammonium bromide (0.0057 moles; 3.7 grams) were added. Stirring was continued for 5 minutes, yielding a clear, yellow homogeneous solution. The addition funnel was charged with 2-ethylhexanoyl chloride (471 grams; 2.89 moles). An initial quantity of 25 mL of 2-ethylhexanoyl chloride was then introduced into the reactor. The ensuing reaction was slow. The temperature of the reactor was then raised to 48° C. A second quantity of about 55 mL of 2-ethylhexanoyl chloride was then introduced from the addition funnel, which resulted in the liberation of gas (hydrogen sulfide), as evidenced by the bubbling observed in the scrubber. A dropwise addition of the 2-ethylhexanoyl chloride was then initiated and maintained at a rate which gave a steady bubbling of hydrogen sulfide. The addition was complete after 2.5 hours.

The temperature setting of the electronic temperature controller was set to 95° C. with continued stirring of the contents of the reactor. When the temperature reached 79° C., more crystals of tetrabutylammonium bromide (11 grams; 0.017 moles) were added, which rapidly dissolved. Then 3-chloro-1-propyltriethoxysilane (682 grams; 2.83 moles) was added to the reactor all at once. The stirring rate was increased to and maintained at 635 revolutions per minute. Within about 10 minutes, the temperature had reached 95° C. and briefly rose 2-3° C. before settling to a steady 95° C. After 2 hours, external heating and agitation were stopped. The mixture rapidly separated into two separate phases.

The contents of the reactor were immediately, while still hot, transferred to a separatory funnel via a cannula tube. The liquid quickly separated into three distinct layers. The bottom aqueous layer and middle layer were drained and discarded. Approximately ⅔ of the remaining organic phase was then immediately transferred to the stripping apparatus. Vacuum was applied gradually with gentle stirring of the contents of the flask until an absolute pressure reading of 0.5 torr was obtained. Ample boiling resulted with no collection of distillate. The vapors, consisting mainly of residual water, collected as a solid in the trap. When boiling ceased, the temperature was gradually raised. At about 90° C., condensate began to appear in the lower portion of the column. The temperature was subsequently raised to 160° C., during which time distillate collected in the collector. When no addition liquid collected, the stripping was stopped. The remaining contents of the distilling flask were allowed to cool and the resulting cloudy, near-colorless liquid was decanted, resulting in a final clear, nearly colorless liquid product with a thin layer of white sediment remaining. The remaining organic phase from the separatory funnel was subsequently treated in an analogous manner.

The final product was initially analyzed by gas chromatography (GC, area %) and mass spectrometry (GCMS), which established that the desired product had been obtained. Purity was measured by gas chromatography (GC, mass %) of the product containing a known weight of an internal standard (heptadecane). The composition of the product was determined to be: 96.03% 3-(2-ethylhexanoylthio)-1-propyltriethoxysilane (target product), 1.94% 3-chloro-1-propyltriethoxysilane, 0.79% 3-mercapto-1-propyltriethoxysilane, 0.18% bis(3-triethoxysilyl-1-propyl)disulfide (TESPD), and 1.06% uneluted heavies (mostly siloxanes).

### Example 3

### Preparation of amyl-(3-triethoxysilyl-1-propyl)xanthate

The reactor consisted of a three-neck 250-mL round bottom flask equipped with a water condenser fitted with a nitrogen bubbler, addition funnel, a Teflon-coated magnetic stir bar, a magnetic stir motor and heating mantle controlled by an electronic temperature controller.

3-Chloro-1-propyltriethoxysilane (12.2 grams; 0.5 mole) was charged into the reactor. Potassium amyl xanthate (10.1 gram; 0.05 mole) and potassium iodide (1.6 grams; 0.01 mole) were added into the reaction flask while stirring vigorously to prevent formation of clumps. The potassium iodide was previously crushed with a mortar and pestle to make it into a fine powder. The mixture was stirred, and heat was applied. The temperature was set to 175° C. The extent of reaction was monitored by removing aliquots and obtaining a gas chromatographic trace. According to the GC trace, after 3 hours of heating at 175° C., only 26% product was obtained in addition to increased formation of unelutable components.

All publications, patents, and patent applications mentioned in this specification are incorporated herein by reference in their entirety to the same extent as if each individual publication, patent, or patent application was specifically and individually indicated to be incorporated by reference in its entirety. Where a term in the present application is found to be defined differently in a document incorporated herein by reference, the definition provided herein is to serve as the definition for the term.

What is claimed is:

1. A rubber composition comprising:
a. at least one diene based polymer;
b. precipitated silica;
c. at least one coupling agent package comprising a mercapto-functional alkylalkoxysilane and a blocked mercapto-functional alkylalkoxysilane;
d. at least one deblocking agent;
e. a vulcanizing package comprising at least one vulcanizing agent comprising sulfur and at least one accelerator;
f. at least one scorch modifier; and
g. optionally at least one filler.

2. The rubber composition of claim 1, wherein the at least one diene based polymer is a diene based polymer containing at least one functional group, a diene based polymer containing no functional group, or combinations thereof.

3. The rubber composition of claim 1, wherein the diene based polymer containing at least one functional group is a compound of formula (I): 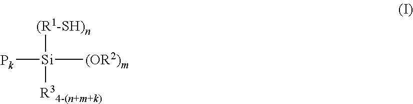
wherein
P is a (co)polymer chain of a conjugated diolefin or a conjugated diolefin and an aromatic vinyl compound; R¹ is an alkylene group having 1 to 12 carbon atoms;
each R² and R³ is independently an alkyl group having 1 to 20 carbon atoms, an allyl group or an aryl group; and
k, m and n are each an integer, wherein n is 1 or 2, m is 1 or 2, and k is 1 or 2, with the proviso that n+m+k is an integer of 3 or 4;
or is a compound of formula (II): 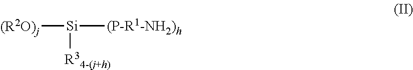
wherein
P is a (co)polymer chain of a conjugated diolefin or a conjugated diolefin and an aromatic vinyl compound;
R¹ is an alkylene group having 1 to 12 carbon atoms;
each R² and R³ is independently an alkyl group having 1 to 20 carbon atoms, an allyl group or an aryl group having 6 to 12 carbon atoms; and
and h are each an integer, wherein j is an integer of 1 to 3, and h is an integer of 1 to 3, with the proviso that j+h is an integer of 2 to 4.

4. The rubber composition of claim 1, wherein the diene based polymer containing at least one functional group is a compound of formula (V) 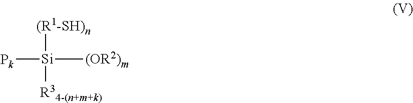
wherein
P is a (co)polymer chain of a conjugated diolefin or a conjugated diolefin and an aromatic vinyl compound,
R¹ is an alkylene group having 1 to 12 carbon atoms;
each R² and R³ is independently an alkyl group having 1 to 20 carbon atoms, an allyl group or an aryl group; and
k, m and n are each an integer, wherein n is 1 or 2, m is 1 or 2, and k is 1 or 2, with the proviso that n+m+k is an integer of 3 or 4.

5. The rubber composition of claim 2, wherein the diene based polymer containing at least one functional group further comprises a terminating agent, wherein the terminating agent is of formula (III): 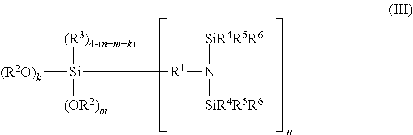
wherein
R¹ is an alkylene group having 1 to 12 carbon atoms;
each R² and R³ is independently an alkyl group having 1 to 20 carbon atoms, an allyl group or an aryl group;
each occurrence of R⁴, R⁵, and R⁶ is independently an alkyl group having 1 to 12 carbon atoms or an aryl group of from 6 to 12 carbon atoms, with the proviso that R⁴ and R⁵may combine through a covalent bond with each other to form a ring together with silicon atoms to which they are bonded; and
k, m and n are each an integer, wherein n is 1 or 2, m is 1 or 2, and k is 1 or 2, with the proviso that n+m+k is an integer of 3 or 4,
or is of formula (IV): 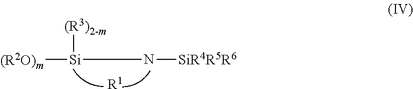
wherein
R¹ is an alkylene group having 1 to 12 carbon atoms;
each R² and R³ is independently an alkyl group having 1 to 20 carbon atoms, an allyl group or an aryl group;
each occurrence of R⁴, R⁵, and R⁶ is independently an alkyl group having 1 to 12 carbon atoms or aryl group of from 6 to 12 carbon atoms, with the proviso that R⁴ and R⁵ may combine through a covalent bond with each other to form a ring together with silicon atoms to which they are bonded; and
m is an integer of 1 or 2.

6. The rubber composition of claim 1, wherein the mercapto-functional alkylalkoxysilane is a mercaptosilane of formula (X): 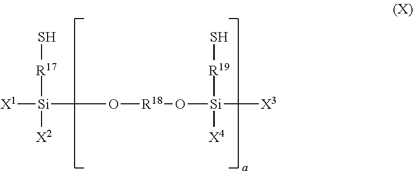
wherein
R¹⁷ is independently a linear alkylene group of from 1 to 6 carbon atoms or a branched alkylene group of from 3 to 6 carbon atoms;
each occurrence of R¹⁸ is an linear alkylene group of from 2 to 8 carbon atoms or a branched alkylene group of from 3 to 8 carbon atoms;
each occurrence of R¹⁹ is independently a linear alkylene group of from 1 to 6 carbon atoms or a branched alkylene group of from 3 to 6 carbon atoms;
X¹ is a —OR²⁰ group, where R²⁰ is an alkyl group of from 1 to 4 carbon atoms, a —OR²¹OH group, wherein R²¹ is a liner alkylene group of from 2 to 8 carbon atoms or a branched alkylene group of from 3 to 8 carbon atom, or X¹ is a —OR²²(OR²³)_{c}OR²²⁴, wherein R²² is a straight chain alkylene group of from 2 to 6 carbon atoms or a branched chain alkylene group of from 3 to 6 carbon atoms, each R²³ is independently an alkylene group of from 2 to 4 carbon atoms and R²⁴ is a straight chain alkyl group of from 1 to 16 carbon atoms or a branched chain alkyl group of from 3 to 16 carbon atoms and c is an integer from 1 to 20;
X² and X³ are independently X¹ or methyl;
each occurrence of X⁴ is independently X¹ or methyl; and
a is an integer from 0 to 8, with the proviso that
(iii) when X¹ and X² are —OR²⁰, then the two —OR²⁰ may be bonded together through a covalent bond to form a —OR²⁰—R²⁰O— group bonded to the same silicon atom which forms a ring structure containing 2 to 8 carbon atoms, two oxygen atoms and a silicon atom; and
(iv) when a is 1 to 8 and X³ and X⁴ are —OR²⁰, then the two —OR²⁰ groups may be bonded together through a covalent bond to form a —OR²⁰—R²⁰O— group, which is bonded to the same silicon atom to form a ring structure containing 2 to 8 carbon atoms, two oxygen atoms and a silicon atom.

7. The rubber composition of claim 1, wherein the blocked mercapto-functional alkylalkoxysilane is a blocked mercaptosilane of formula (XI): 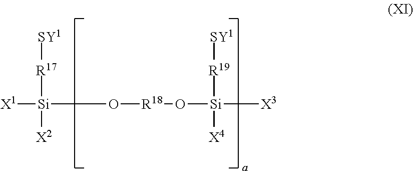
wherein
R¹⁷ is independently a linear alkylene group of from 1 to 6 carbon atoms or a branched alkylene group of from 3 to 6 carbon atoms;
each occurrence of R¹⁸ is an linear alkylene group of from 2 to 8 carbon atoms or a branched alkylene group of from 3 to 8 carbon atoms;
each occurrence of R¹⁹ is independently a linear alkylene group of from 1 to 6 carbon atoms or a branched alkylene group of from 3 to 6 carbon atoms;
X¹ is a —OR²⁰ group, where R²⁰ is an alkyl group of from 1 to 4 carbon atoms, a —OR²¹OH group, where R²¹ is a linear alkylene group of from 2 to 8 carbon atoms or a branched alkylene group of from 3 to 8 carbon atom, or X¹ is a —OR²²(OR²³)_{c}OR²²⁴, where R²² is a straight chain alkylene group of from 2 to 6 carbon atoms or a branched chain alkylene group of from 3 to 6 carbon atoms, preferably 3 carbon atoms, each R²³ is independently an alkylene group of from 2 to 4 carbon atoms and R²⁴ is a straight chain alkyl group of from 1 to 16 carbon atoms or a branched chain alkyl group of from 3 to 16 carbon atoms and c is an integer from 1 to 20;
X² and X³ are independently X¹ or methyl;
each occurrence of X⁴ is independently X¹ or methyl;
each occurrence of Y¹ is —C(═O)R²⁵ or —C(═S)OR²⁵, wherein each R²⁵ is independently a straight chain alkylene group of from 1 to 16 carbon atoms, more specifically from 5 to 11 carbon atoms and even more specifically from 6 to 9 carbon atom, or a branched chain alkylene group of from 3 to 16 carbon atoms, more specifically from 5 to 11 carbon atoms and even more specifically 6 to 9 carbon atoms; and
a is an integer of from 0 to 8, with the proviso that
(iii) when X¹ and X² are —OR²⁰, then the two —OR²⁰ may be bonded together through a covalent bond to form a —OR²⁰—R²⁰O— group bonded to the same silicon atom which forms a ring structure containing 2 to 8 carbon atoms, two oxygen atoms and a silicon atom; and
(iv) when a is 1 to 8 and X³ and X⁴ are —OR²⁰, then the two —OR²⁰ groups may be bonded together through a covalent bond to form a —OR²⁰—R²⁰O— group, which is bonded to the same silicon atom to form a ring structure containing 2 to 8 carbon atoms, two oxygen atoms and a silicon atom.

8. The rubber composition of claim 1, wherein the weight ratio of the blocked mercapto-functional alkylalkoxysilane to the mercapto-functional alkylalkoxysilane is from about 0.25:1 to about 50:1.

9. The rubber composition of claim 1, wherein the at least one deblocking agent is a compound of formula (XII):
R²⁶[A³-H]_{d} (XII)
wherein:
R²⁶ is a monovalent or polyvalent organic radical containing from 1 to 30 carbon atoms or hydrogen,
each occurrence of A³ is independently an oxygen, sulfur or —NR²⁷ group, where each occurrence of R²⁷ is independently a monovalent or polyvalent organic radical containing from 1 to 30 carbon atoms or hydrogen; and
d is an integer of from 1 to 100, preferably from 1 to 3.

10. The rubber composition of claim 1, wherein the sulfur in the vulcanizing agent is selected from the group consisting of elemental sulfur, sulfur-donating compounds, and combinations thereof.

11. The rubber composition of claim 1, wherein the at least one accelerator is selected from the group consisting of benzothiazoles, guanidine derivatives, thiocarbamates, and combinations thereof.

12. The rubber composition of claim 1, wherein the at least one scorch modifier is a compound of formula (XIII)
R²⁸₂NC(═S)SSC(═S)NR²⁸₂ (XIII)
wherein
R²⁸ is independently a straight chain alkyl group of from 1 to 12 carbon atoms, a branched chain alkyl group of from 3 to 12 carbon atoms, a cycloalkyl group of from 5 to 12 carbon atoms, an aryl group of from 6 to 12 carbon atoms and an aralkyl group of from 7 to 12 carbon atoms.

13. The rubber composition of claim 1, wherein the at least one diene based polymer is reactive with the precipitated silica.

14. The rubber composition of claim 1, wherein the composition has a Mooney viscosity from about 40 MU to about 150 MU as measured using the ASTM D-1646 method.

15. The rubber composition of claim 1, wherein the composition has Mooney scorch, 3 pt rise, of from about 5 minutes to about 40 minutes as measured using the ASTM D-1646 method.

16. The rubber composition of claim 1, wherein the composition has a tensile strength of from about 5 MPa to about 25 MPa as measured using the ASTM D-412 method.

17. A rubber composition comprising:
(i) about 100 parts of rubber, where the weight of the rubber is the sum of the weights of each diene based polymer containing at least one function group used in the formulation and the sum of the weights of each diene based polymer used in the formulation which does not contain at least one functional group;
(ii) about 5 to about 140 parts by weight per 100 parts rubber (i) of precipitated silica;
(iii) about 1 to about 20 parts by weight per 100 parts rubber (i) a coupling agent package comprising a mercapto-functional alkylalkoxysilane and a blocked mercapto-functional alkylalkoxysilane;
(iv) about 0.1 to about 20 parts by weight per 100 parts rubber (i) a deblocking agent;
(v) about 0.1 to about 10 parts by weight per 100 parts rubber (i) a vulcanization package comprising sulfur and at least one accelerator; and
(vi) about 0.1 to about 5 parts by weight per 100 parts rubber (i) a scorch modifier.

18. A process of preparing a composition comprising adding silica, a mercapto-functional alkylalkoxysilane, a blocked mercapto-functional alkylalkoxysilane, and optionally adding at least one scorch modifier at the same time as a vulcanization package comprising at least one vulcanizing agent comprising sulfur and at least one accelerator to at least one diene based polymer.

19. The process of claim 18, wherein the composition comprises
a. about 30% to about 40% by weight of at least one diene based polymer containing at least one functional group;
b. about 30% to about 40% by weight of a precipitated silica;
c. about 0.05% to about 5% by weight of a blocked mercapto-functional alkylalkoxysilane;
d. about 0.05% to about 5% by weight of a mercapto-functional alkylalkoxysilane;
e. about 0.1% to about 10% by weight of a scorch modifier; and
f. optionally a vulcanization package comprising at least one vulcanizing agent comprising sulfur and at least one accelerator.

20. A composition prepared by the process of claim 18, wherein the composition is a rubber composition.

21. The rubber composition of claim 20, wherein the rubber composition is a tire composition.
